(19) United States
(12) Patent Application Publication
(10) Pub. No.: US 2011/0075080 A1
(43) Pub. Date: Mar. 31, 2011

(54) RETARDATION FILM, METHOD OF PRODUCING THE RETARDATION FILM, AND POLARIZING PLATE AND LIQUID-CRYSTAL DISPLAY DEVICE HAVING THE SAME

(75) Inventors: Yujiro YANAI, Minami-ashigara-shi (JP); Yasunori KOBAYASHI, Minami-ashigara-shi (JP); Takahiro OHNO, Minami-ashigara-shi (JP)

(73) Assignee: FUJIFILM CORPORATION, Tokyo (JP)

(21) Appl. No.: 12/894,885

(22) Filed: Sep. 30, 2010

(30) Foreign Application Priority Data
Sep. 30, 2009 (JP) 2009-228366

(51) Int. Cl. G02F 1/1335; G02B 1/08; B29D 11/00

(52) U.S. Cl. 349/117; 359/500; 264/1.1

(57) ABSTRACT

Disclosed is a retardation film comprising, as laminated in the thickness direction thereof, at least two layers of an optically anisotropic layer A containing at least one refractivity-anisotropic substance and a polymer A and an optically anisotropic layer B containing at least one refractivity-anisotropic substance in a ratio smaller than that in the optically anisotropic layer A, or not containing a refractivity-anisotropic substance, and containing a polymer B of which the main ingredient is the same as that of the polymer A, wherein the Nz factor of the optically anisotropic layers A and B intermittently differs in the thickness direction of the film.

### CROSS-REFERENCE TO RELATED APPLICATIONS

This application claims benefit of priority under 35 U.S.C. 119 to Japanese Patent Application No. 2009-228366 filed on Sep. 30, 2009; and the entire contents of the application are incorporated herein by reference.

### BACKGROUND OF THE INVENTION

1. Field of the Invention

The present invention relates to a retardation film useful as a component part of liquid-crystal display devices and others, to a method of producing the retardation film, and to a polarizing plate and a liquid-crystal display device having the retardation film.

2. Related Art

Applications of liquid-crystal display devices are expanding year by year as power-saving and space-saving image display devices. Heretofore, one serious defect of liquid-crystal display devices is that the viewing angle dependence of image display is large. However, VA-mode or IPS-mode, wide viewing angle liquid-crystal display devices have been put into practical use, and in that situation, the demand for liquid-crystal display devices is rapidly expanding even in the market of TVs and others that require high-definition image expression.

Various optical compensation mechanisms have been proposed for those modes of liquid-crystal display devices.

For example, JP-A 2006-220971 proposes an optical compensatory sheet that comprises a predetermined optically anisotropic layer A and a predetermined optically anisotropic layer C in that order, saying that use of the optical compensatory sheet has improved the viewing angle characteristics of VA-mode liquid-crystal display devices.

JP-T 2008-544317 discloses a multilayer compensator comprising a first layer and a second layer that differ in the refractive index.

JP-A 2006-83357 discloses a cellulose acylate film of which the degree of substitution of the cellulose acylate varies within a predetermined range in the direction of the thickness of the film.

These films have an interfacial layer of different materials inside them, and therefore the s-wave and the p-wave of the polarized light running therethrough in an oblique direction differ in the transmittance. The transmittance is a value that is proportional to the square of the amplitude; and the stokes parameter indicating the polarization state (S1=Ap²−As², S2=2ApAs×cos δ, S3=2ApAs×sin δ where Ap means the amplitude of the p-wave, As means the amplitude of the s-wave, and δ means the retardation) is also a value that is proportional to the square of the amplitude. In other words, before and after passing through the interface, the polarization of the light changes owing to the amplitude change. Accordingly, in order that the films could attain the intended polarization state, the films require the action in consideration of this influence thereon and are therefore unfavorable since they would be complicated, and in addition, the front transmittance through the films also lowers and the films are unfavorable in point of the light use efficiency.

Further, JP-A 2006-323152 proposes a transparent film of which the ratio of Re to Rth, Re/Rth varies in the direction of the thickness of the film, as an optical compensatory film of liquid-crystal display devices, especially VA-mode liquid-crystal display devices; however, this does not concretely illustrate the relationship between the Re/Rth change and the concentration change of the refractivity-anisotropic material.

A retardation film is disclosed, which comprises a material having refractivity anisotropy in the film thickness direction and in which the material has a concentration gradient in the film thickness direction (JP-A 2006-221134). However, in JP-A 2006-221134, the material having refractivity anisotropy is controlled to have a concentration gradient for the purpose of enhancing the adhesiveness between the retardation film and the polarizing film to be adjacent thereto; but this reference describes nothing relating to the optical characteristics of the retardation film that may result from the concentration gradient.

On the other hand, various proposals have been made for a method of producing a retardation film through co-casting. JP-A 2003-14933 discloses a method for producing a retardation film, which comprises preparing a dope A containing a resin, an additive and an organic solvent, and a dope B not containing an additive or containing a resin, an additive and an organic solvent, in which, however, the content of the additive is smaller than that in the dope A, followed by co-casting the two in such a manner that the dope A could form a core layer and the dope B could form a surface layer. However, JP-A 2003-14933 is for the purpose of improving the slidability and the transparency of the retardation film but not for improving the optical characteristics thereof. For example, in Examples in JP-A 2003-14933, films are produced which are so planned that both surfaces of the core layer of the dope A are sandwiched between the surface layers of the dope B. In other words, there is given no concrete description therein relating to a method of positively providing a difference in the optical characteristics between the surface and the back of the film.

### SUMMARY OF THE INVENTION

The present invention has been made in consideration of the above-mentioned problems, and its object is to provide a novel retardation film capable of contributing toward improving the viewing angle characteristics of liquid-crystal display devices, especially VA-mode liquid-crystal display devices and having good producibility, to provide a stable method for producing the film, and to provide a polarizing plate and a liquid-crystal display device comprising the film.

The means for achieving the above-mentioned objects are as follows:

[1] A retardation film comprising, as laminated in the thickness direction thereof, at least two layers of an optically anisotropic layer A containing at least one refractivity-anisotropic substance and a polymer A and an optically anisotropic layer B containing at least one refractivity-anisotropic substance in a ratio smaller than that in the optically anisotropic layer A, or not containing a refractivity-anisotropic substance, and containing a polymer B of which the main ingredient is the same as that of the polymer A, wherein the Nz factor of the optically anisotropic layers A and B intermittently differs in the thickness direction of the film.
[2] The retardation film of [1], wherein the difference in the Nz factor of the optically anisotropic layers A and B is equal to or larger than 2.0.
[3] The retardation film of [1] or [2], wherein the circular retardation at a wavelength of 550 nm in the direction at a polar angle of 60 degrees and an azimuth angle of 45 degrees is equal to or larger than 0.5 nm.
[4] The retardation film of any one of [1]-[3], which is formed by stretching a laminate of at least two layers of the optically anisotropic layer A and the optically anisotropic layer B formed through co-casting.
[5] The retardation film of any one of [1]-[4], which has Re-off of from 50 to 80 nm and Rth-off of from 190 to 230 nm.
[6] The retardation film of any one of [1]-[4], which has Re-off of from 45 to 65 nm and Rth-off of from 110 to 130 nm.
[7] The retardation film of any one of [1]-[6], of which the in-plane retardation Re and the thickness-direction retardation Rth show the same wavelength dispersion characteristics in a visible light region.
[8] The retardation film of any one of [1]-[6], of which the in-plane retardation Re and the thickness-direction retardation Rth show different wavelength dispersion characteristics in a visible light region.
[9] The retardation film of any one of [1]-[8], wherein the optically anisotropic layers A and B contain at least one cellulose acylate as a main ingredient.
[10] The retardation film of any one of [1]-[9], wherein the optically anisotropic layers A and B contain at least one cellulose acylate having at least two acylates selected from acetyl, propionyl and butyryl.
[11] The retardation film of any one of [1]-[10], wherein the at least one refractivity-anisotropic substance is a discotic compound having an absorption peak at a wavelength of from 250 nm to 380 nm.
[12] The retardation film of any one of [1]-[11], wherein the at least one refractivity-anisotropic substance is a liquid crystal compound.
[13] The retardation film of any one of [1]-[12], wherein the at least one refractivity-anisotropic substance is a compound represented by formula (A):

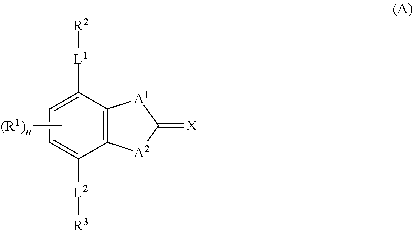

where L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

[14] The retardation film of any one of [1]-[13], wherein the at least one refractivity-anisotropic substance is a compound represented by formula (a):

Ar¹-L²-X-L³-Ar² (a)

where Ar¹ and Ar² independently represent an aromatic group; L¹² and L¹³ independently represent —O—CO— or —CO—O—; X represents 1,4-cyclohexylen, vinylene or ethynylene.

[15] The retardation film of any one of [1]-[14], wherein the at least one refractivity-anisotropic substance is a compound represented by formula (I)

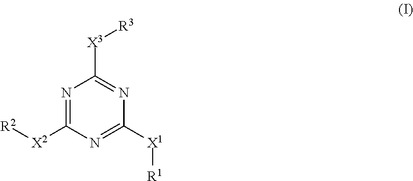

where X¹ represents a single bond, —NR⁴—, —O— or —S—; X² represents a single bond, —NR⁵—, —O— or —S—; X³ represents a single bond, —NR⁶—, —O— or —S—; R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

[16] The retardation film of any one of [1]-[15] having a thickness of from 30 to 200 micro meters.
[17] A method of producing a retardation film of any one of [1]-[16], which comprises:

preparing a liquid A that contains at least one polymer as the main ingredient and at least one refractivity-anisotropic material, and a liquid B1 that contains at least one polymer as the main ingredient but does not contain at least one refractivity-anisotropic material, or a liquid B2 that contains at least one polymer as the main ingredient and contains at least one refractivity-anisotropic material in a ratio smaller than that in the liquid A,

co-casting the liquid A and the liquid B1 or B2 onto the surface of a support to form a film thereon, and

stretching the film.

[18] The method of [17], wherein the film is stretched at a draw ratio of from 1 to 300%.
[19] The method of [17] or [18], wherein the liquid B1 or B2 is cast on the side nearer to the surface of the support.
[20] The method of any one of [17]-[19], which comprises preparing, along with the liquid A and the liquid B1 or B2, or in place of these, a liquid a having the same formulation as that of the liquid A but having a lower concentration than that of the liquid A, and/or a liquid b1 or b2 having the same formulation as that of the liquid B1 or B2 but having a lower concentration than that of the liquid B1 or B2, and co-casting them in the following order from the support surface side:

the liquid b1, the liquid B1 and the liquid a;

the liquid b1, the liquid A and the liquid a;

the liquid b2, the liquid A and the liquid a;

the liquid b1, the liquid B1, the liquid A and the liquid a; or

the liquid b2, the liquid B2, the liquid A and the liquid a.

[21] The method of any one of [17]-[20], wherein the formulation of the liquid A and the liquid B1 or B2 satisfies the following condition:

### (Condition)

when the liquid A and the liquid B1 or B2 are each independently cast under the same condition and then stretched under the same condition, the Nz factor of the resulting two films differs by at least 2.0.

[22] A polarizing plate comprising a polarizing film and a retardation film of any one of [1]-[16] on at least one surface of the polarizing film.
[23] The polarizing plate of [22], wherein the surface having a higher Nz factor of the retardation film is stuck to at least one surface of the polarizing film.
[24] A liquid crystal display device comprising:

a liquid crystal cell,

at least one polarizing film, and

a retardation film of any one of [1]-[16] disposed between the liquid crystal cell and the polarizing film.

[25] The liquid crystal display device of [24], employing a vertically-aligned mode.

### BRIEF DESCRIPTION OF THE DRAWINGS

FIG. 1 shows schematic views used for explaining the change in the prospective angle of a polarizing plate.

FIG. 2 shows schematic views used for explaining the polar angle dependence of the retardation of an index ellipsoid (VA-mode liquid-crystal layer).

FIG. 3 shows schematic views of one example of the polarization state of the incident light after having passed through a backlight-side polarizing plate and (i) a conventional retardation film or (ii) a retardation film of the invention, as graphically drawn on a Poincare sphere.

FIG. 4 shows a schematic view of one example of the polarization state of the incident light after having passed through a backlight-side polarizing plate and (i) a conventional retardation film or (ii) a retardation film of the invention, as graphically drawn on a Poincare sphere.

FIG. 5 shows a schematic view of the trace of the polarization state of the light coming in a retardation film of the invention in the direction at a polar angle of 60° and at an azimuth angle of 45° and passing through the film, as graphically drawn on a Poincare sphere.

### DETAILED DESCRIPTION OF THE INVENTION

The invention is described hereinunder. In this description, the numerical range expressed by the wording “a number to another number” means the range that falls between the former number indicating the lowermost limit of the range and the latter number indicating the uppermost limit thereof.

At first, the definitions of the terms described in this description will be explained.

### (Retardation Re and Rth)

In this description, Re(λ) and Rth(λ) are an in-plane retardation (nm) and a thickness-direction retardation (nm), respectively, at a wavelength of λ. Re(λ) is measured by applying light having a wavelength of λ nm to a film in the normal direction of the film, using KOBRA 21ADH or WR (by Oji Scientific Instruments).

When a film to be analyze by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (X) and (XI):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( X ) \\ R th = \{ ( nx + ny ) / 2 - nz \} \times d & ( XI )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In the description, the “visible light region” is from 380 nm to 780 nm. Unless otherwise specifically indicated in this description, the measurement wavelength is 550 nm.

In this description, the numerical data, the numerical range and the qualitative expression (for example, “equivalent”, “same”, etc.) indicating the optical characteristics of component parts such as retardation film, liquid-crystal layer and others should be so interpreted as to indicate the numerical data, the numerical range and the qualitative expression that include the error range generally acceptable for liquid-crystal display devices and their component parts.

The regular wavelength dispersion characteristics of Re and Rth of a film mean the properties of the film of such that the retardation Re and Rth of the film is larger at a shorter wavelength in a visible light region; and on the contrary, the reversed wavelength dispersion characteristics of Re and Rth of a film mean the properties of the film of such that the retardation Re and Rth of the film is smaller at a shorter wavelength in a visible light region. In this description, the retardation data are compared with each other at a wavelength of 550 nm and a wavelength of 450 nm. Regarding Re of a film, for example, when the film satisfies Re(550)/Re(450) 0.99, then the film exhibits regular wavelength dispersion characteristics of Re; and when the film satisfies Re(550)/Re(450) 1.01, then the film exhibits reversed wavelength dispersion characteristics of Re. The film with 0.99<Re(550)/Re(450)<1.01 exhibits no wavelength dispersion characteristics of Re.

In this description, the Nz factor of a film in the thickness direction thereof is determined according to the method mentioned below.

A sample of a film is cut obliquely at a tilt angle of from 1° to 2° relative to the film surface. The sample is analyzed for the retardation in a microscopic region. For example, using a microscopic area retardation analyzer, Oji Scientific Instruments' KOBRA-CCD Series, the thickness direction Re and Rth of the sample are measured according to the same method as above. Based on the data, Re, Rth and the Nz factor (=Rth/Re+0.5) of the sample are computed. For example, for a two-layer sample, Re/Rth of the first layer of the sample is first determined, and the Nz factor thereof is then determined. Next, Re/Rth of the laminate of the first layer and the second layer is determined. Since Re/Rth of the first layer is known, Re/Rth and the Nz factor of the second layer alone could be computed based on the known data. For more multilayer samples, the same shall apply to compute Re/Rth and the Nz factor thereof. When the sample is analyzed in tens of μm, the Nz factor thereof could be computed as a value averaged in tens of μm. The unit length for measurement is preferably smaller, and is, for example, preferably nor more than 5 μm. The measurement limit will be 1 μm or so.

In this description, the wording “the Nz factor differs intermittently in the thickness direction” means that the Nz factor of the film computed according to the above method is constant in a range of from 5 to 10 μm in the thickness direction thereof and the film has at least two regions that differ in the Nz factor by at least 2.0.

### 1. Retardation Film:

The retardation film of the invention comprises at least two layers, as laminated in the thickness direction thereof, of an optically anisotropic layer A containing at least one refractivity-anisotropic substance and a polymer A, and an optically anisotropic layer B containing at least one refractivity-anisotropic substance in a ratio smaller than that in the optically anisotropic layer A, nr not containing a refractivity-anisotropic substance, and containing a polymer B of which the main ingredient is the same as that of the polymer A, wherein the Nz factor of the optically anisotropic layer A and the optically anisotropic layer B differs intermittently in the thickness direction of the film.

As a result of assiduous studies, the present inventors have found that the film of the type enables optical compensation on the same level as before even when its Re is reduced. The principle of optical compensation in liquid-crystal displays and the concept of the invention are described below.

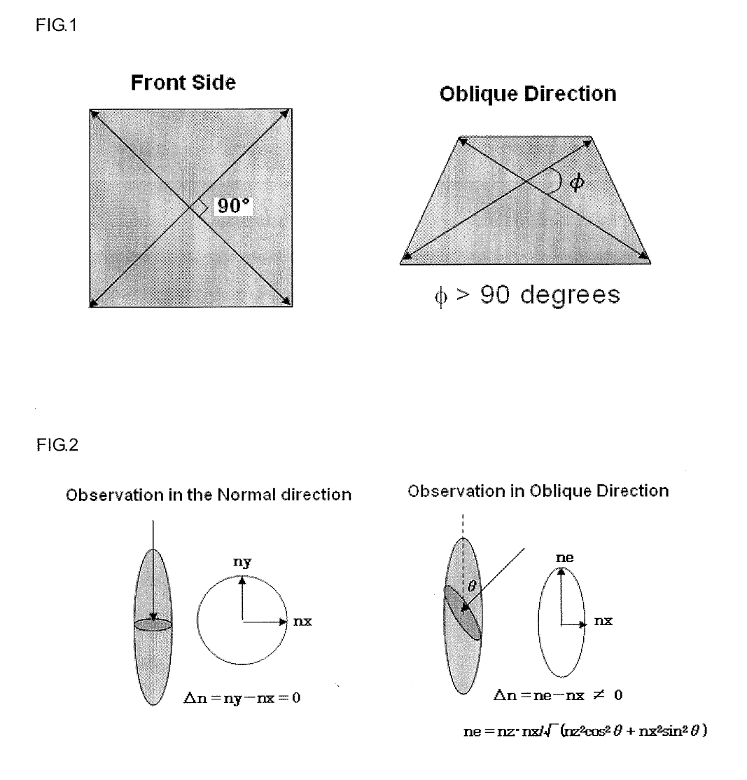

The role of the retardation film in a liquid-crystal display is to compensate the light leakage owing to the prospective angle change in observation at an oblique direction (for example, at a polar angle of 60 degrees and an azimuth angle of 45 degrees) of a pair of polarizing plates arranged in such a manner that the polarization axes thereof are perpendicular to each other (FIG. 1), and the refractivity anisotropy of the liquid-crystal layer existing between the pair of polarizing plates. For example, in a VA-mode liquid-crystal cell, the liquid-crystal material is a rod-like liquid crystal, and the retardation susceptible to light differs between observation in the front direction and observation in an oblique direction, or that is, the value in the former is 0 but the value in the latter is not 0 (FIG. 2).

FIG. 3 shows one example of the polarization state of the incident light after having passed through a rear-side polarizing plate and a retardation film for a VA-mode at a polar angle of 60 degrees and an azimuth angle of 45 degrees, as graphically drawn on a Poincare sphere. FIG. 3(i) is an example where a conventional retardation film is used. Of the conventional retardation film, Nz is uniform in the thickness direction thereof, and therefore, the change in the polarization of light passing through the retardation film is uniform on the sphere around the center of a rotation axis, and is represented by the rotation of the angle proportional to the refractivity anisotropy of the retardation film.

However, for compensation, the final polarization state after having passed through a retardation film may be the same irrespective of the route of the polarization state on Poincare sphere, or that is, there may be an indefinitely large number of the routes. On the Poincare sphere, the Nz factor corresponds to the rotation axis, and when the Nz factor of a retardation film changes in the film thickness direction, then the route could be changed along the way. In addition, since the refractivity anisotropy of a retardation film corresponds to the amount of rotation, the amount of rotation in different routes could be controlled depending on the level of the refractivity anisotropy. In one example of the retardation film of the invention, the incident light polarization state is first moved in the plus (+) direction of S3 (in the north pole direction), and then the route could be so controlled that the final polarization state from the starting point could be the same, as in FIG. 3(ii). As a result, the present inventors have found that even though Re of the retardation film of the invention is smaller than Re of a retardation film of which Re is uniform, the retardation film of the invention could attain the same compensation.

FIG. 3(ii) merely shows the action of only one example of the retardation film of the invention, and the retardation film of the invention should not be limited to the film exhibiting the effect of FIG. 3(ii).

The difference in the Nz factor of the optically anisotropic layers A and B of the retardation film of the invention is preferably at least 2.0, more preferably at least 5.0, even more preferably at least 10.0.

In this description, Re-off and Rth-off indicating Re and Rth, respectively, in an oblique direction of the retardation film of the invention are defined as follows:

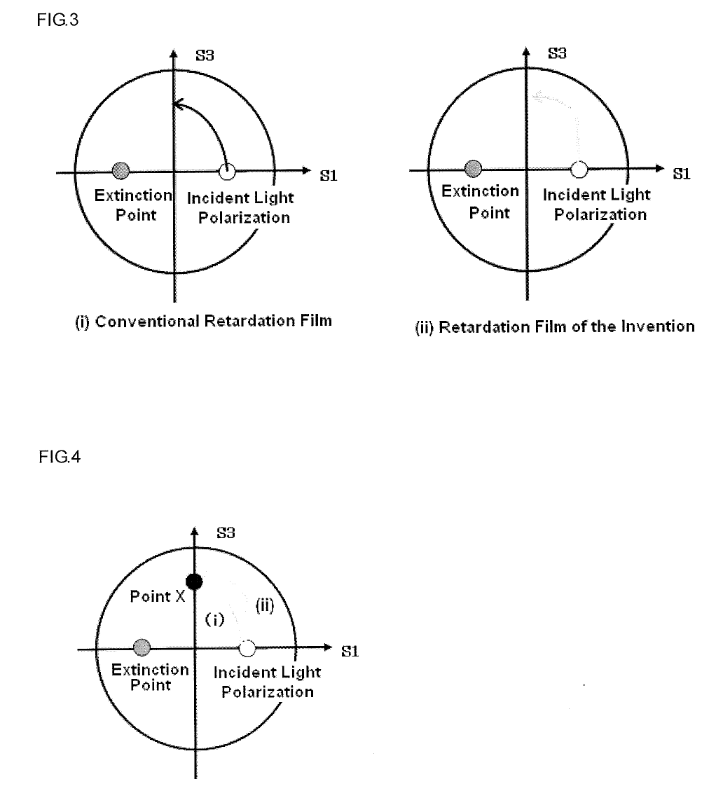

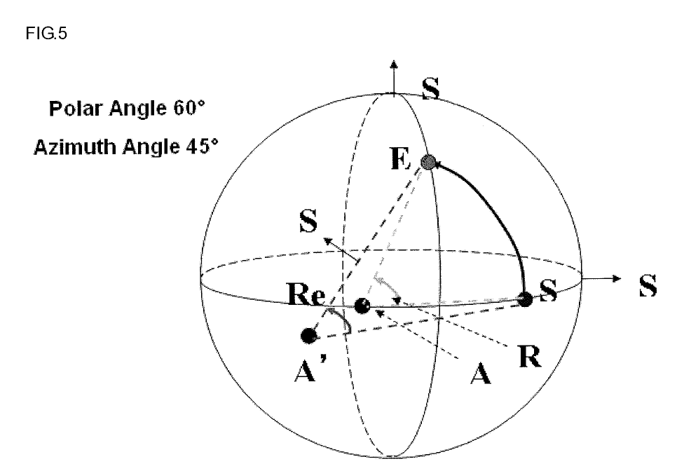

The polarization state of an incident light in the direction at a polar angle of 60° and an azimuth angle of 45°, after having passed through the retardation film of the invention, is in the position of the point X on the Poincare sphere of FIG. 4. Regarding the retardation film of which the Nz factor is uniform in the thickness direction, Re is Re₀ and Rth is Rth₀, when the polarization state of the incident light in the same direction, after having passed through the retardation film, is the same as above (or that is, the polarization state is in the position X in FIG. 4), then Re-off=Re₀, and Rth-off=Rth₀.

A conventional retardation film of a biaxial film of which the Nz factor is uniform in the thickness direction has Re=Re-off and Rth=Rth-off; and for this, therefore, it will be unnecessary to take the above into consideration. However, in the retardation film of the invention, not the conventional Re and Rth (Re and Rth measured in the axial direction (that is, in the normal direction relative to the film surface)) but Re-off and Rth-off actually correspond to the final polarization state in compensation in an oblique direction.

Mathematically, the Jones matrix in each layer of the laminate is represented by J, the incident polarization state is by Pin and the final polarization state is by Pout; and the polarization state of the light, after having passed through the laminate composed of n layers, could be represented by the following formula (I):

Pout=Jₙ×Jₙ₋₁× . . . ×J₂J₁×Pin (i)

On the other hand, the polarization state through one layer could be represented by the following:

Pout=J×Pin (ii)

In other words, it may be considered that J in the formula (ii) could be equivalent to the value computed through multiplication of the Jones matrix values of the constitutive layers in the formula (I); and based on this, Re-off and Rth-off could be computed from the Jones matrix of the formula (II).

The preferred range of Re-off and Rth-off of the retardation film of the invention will vary depending on the use of the film.

In an embodiment of using the film for optical compensation in a VA-mode liquid-crystal display device, or that is, in an embodiment of one-sheet compensation of using a biaxial film on the back side or the panel side of the liquid-crystal cell, Re-off is preferably within a range of from 40 to 90 nm, more preferably from 50 to 80 nm, even more preferably from more than 50 to less than 80 nm, and Rth-off is preferably within a range of from 170 to 250 nm, more preferably from 190 to 230 nm, even more preferably from more than 190 to less than 230 nm.

In an embodiment of symmetric two-sheet compensation of using two biaxial films both having nearly the same optical characteristics as the retardation film to be arranged on the back side and the panel side of the liquid-crystal cell, Re-off is preferably within a range of from 35 to 75 nm, more preferably from 45 to 65 nm, even more preferably from more than 45 to less than 65 nm, and Rth-off is preferably within a range of from 90 to 150 nm, more preferably from 110 to 130 nm, even more preferably from more than 110 to less than 130 nm.

The wavelength dispersion characteristics of Re-off and Rth-off of the retardation film of the invention are not specifically defined.

One example is a retardation film of which the wavelength dispersion characteristics are the same both for Re-off and Rth-off thereof in a visible light range; and another example is a retardation film of which the wavelength dispersion characteristics differ between Re-off and Rth-off thereof in a visible light range. The wavelength dispersion characteristics of Re-off and Rth-off of the retardation film of the invention can be more concretely represented by the value computed by adding the wavelength dispersion characteristic data of retardation of each constitutive layer, by controlling the wavelength dispersion characteristics of dispersion of each constitutive layer. The wavelength dispersion characteristics of Re (Rth) of the retardation film of the invention is also computed by adding the wavelength dispersion characteristic data of Re (Rth) of each constitutive layer, and the level thereof is nearly the same as that of Re-off and Rth-off of the film; and accordingly, the wavelength dispersion characteristics of retardation of the film could be known from the found data of retardation of the film.

For VA-mode liquid-crystal display devices, is said that the retardation film preferably has reversed wavelength dispersion characteristics of Re and has regular wavelength dispersion characteristics of Rth. The retardation film of the invention could be the preferred embodiment of the retardation film of the type by making one layer (optically anisotropic layer A or B) thereof have Re-off/Rth-off of reversed wavelength dispersion characteristics/reversed wavelength dispersion characteristics and making the other layer (optically anisotropic layer B or A) thereof have Re-off/Rth-off of regular wavelength dispersion characteristics/regular wavelength dispersion characteristics, and by controlling the degree of wavelength dispersion characteristics of retardation of each constitutive layer.

As a result of various studies, the present inventors have found that the retardation film of the invention of which the Nz factor intermittently varies in the thickness direction could exhibit circular retardation. In general, when the trace of the linear polarized light running into a retardation film in an oblique direction is shown on a Poincare sphere, it may be expressed as rotation around the axis on a point on the equatorial line, and the amount of rotation is proportional to Re of the retardation film. On the other hand, when the trace of the linear polarized light running into a retardation film expressing circular retardation is shown on a Poincare sphere, it may be expressed as rotation around the axis on a point deviated from the equatorial line. For example, for reducing the light leakage occurring in oblique directions at the time of black level of display in a VA-mode liquid-crystal cell, it is said to be preferable that the light in an oblique direction is, before running into the VA-mode liquid-crystal cell at the time of black level of display, transferred from the linear polarization S to the polarization state E, as shown in FIG. 5. Use of a retardation film that expresses a circular retardation to thereby transfer the rotation axis of the polarization state transition from on the equatorial line (λ) to on the south hemisphere (A′) may enable the transition to the polarization state E at a smaller amount of rotation (Re′) than the amount of rotation (Re) in the case where the axis is on the equatorial line. As a result of investigations, the present inventors have found that the retardation film of the invention satisfying the above-mentioned condition expresses a circular retardation and can attain a larger polarization state change at a smaller retardation. The retardation film of the invention enables a larger polarization state transition, even though having retardation on the same level as that of a conventional retardation film.

The circular retardation can be measured, for example, using Axometry (by Axometrics Inc). Not limited to this, any other apparatus capable of measuring a Mueller matrix can also be used. The method of computing the circular retardation from the Mueller matrix is described in detail in J. Opt. Soc. Am. A, Vol. 13, No. 5, p. 1106, etc.

In the invention, all the starting materials of the retardation film can be made uniform (for example, in the optically anisotropic layers A and B, the polymer of the main ingredient and the refractivity-anisotropic material can be the same). The retardation film of the embodiment can be recovered and recycled. Accordingly, from the viewpoint of the recyclability, the compositions for the optically anisotropic layers A and B are preferably the same in the two except for the concentration of the refractivity-anisotropic material.

Also from the viewpoint of the optical characteristics except the recyclability of the retardation film, it is advantageous that the main ingredient of the retardation film is uniform throughout the film. Concretely, when the film is made to have a difference in the refractivity anisotropy by changing the type of the main ingredient polymer, the inside of the polymer could have an interface of different materials, and as a result, the s-wave and the p-wave of the incident light running into the film in an oblique direction could differ in the transmittance thereof. The transmittance is a value that is proportional to the square of the amplitude; and the stokes parameter indicating the polarization state (S1=Ap²−As², S2=2ApAs×cos δ, S3=2ApAs×sin δ where Ap means the amplitude of the p-wave, As means the amplitude of the s-wave, and δ means the retardation) is also a value that is proportional to the square of the amplitude. In other words, before and after passing through the interface, the polarization of the light changes owing to the amplitude change, Accordingly, in order that the films could attain the intended polarization state, the films require the action in consideration of this influence thereon and are therefore unfavorable since they would be complicated, and in addition, the front transmittance through the films also lowers and the films are unfavorable in point of the light use efficiency.

In the retardation film of the invention, the polymer material to be the main ingredient is the same throughout the film, and the presence of an interface inside the film could be evaded as much as possible, and this is favorable since the above-mentioned problem could be negligible.

Next, the materials and methods which can be used for preparing the retardation film of the invention will be described.

The optically anisotropic layers A and B of the retardation film of the invention each contain at least one polymer as the main ingredient thereof. The main ingredient means the ingredient having a higher content of all the constitutive ingredients of the film. The polymer A of the main ingredient of the optically anisotropic layer A is preferably the same as the polymer B of the main ingredient of the optically anisotropic layer B. However, in this description, the formulation of the polymer A may not be completely the same as that of the polymer B, and for example, in an embodiment where the polymer A comprises two or more different types of polymers, the polymer B may contain at least the main ingredient polymer of the polymer A as the main ingredient thereof. In an embodiment where the polymer A is at least one cellulose acylate to be mentioned below, the polymer B must also comprise at least one cellulose acylate, but in this, the polymers A and B may differ in the degree of acyl substitution of the cellulose acylate.

The main ingredient, which is contained in the optically anisotropic layers A and B of the retardation film of the invention, may be selected from various polymers in terms of optical characteristics, transparency, mechanical strength, thermal stability, moisture-nonpermeability, isotropy and the like. Examples of the polymer include polycarbonate-type polymer, polyester-type polymer such as polyethylene terephthalate and polyethylene naphthalate, acrylic polymer such as polymethyl methacrylate, and styrenic polymer such as polystyrene and acrylonitrile/styrene copolymer (AS resin). In addition, also employable are polyolefin-type polymer, for example, polyolefin such as polyethylene and polypropylene, and ethylene/propylene copolymer; vinyl chloride-type polymer; amide-type polymer such as nylon and aromatic polyamide; imide-type polymer, sulfone-type polymer, polyether sulfone-type polymer, polyether-ether ketone-type polymer, polyphenylene sulfide-type polymer, vinylidene chloride-type polymer, vinyl alcohol-type polymer, vinyl butyral-type polymer, arylate-type polymer, polyoxymethylene-type polymer, epoxy-type polymer; and mixed polymer of the above polymers.

As the main ingredient of the optically anisotropic layers A and B, preferably used is a thermoplastic norbornene-type resin. The thermoplastic norbornene-type resin includes Nippon Zeon's ZEONEX and ZEONOR, and JSR's ARTON, etc.

As the main ingredient of the optically anisotropic layers A and B, especially preferred is a cellulose polymer heretofore used as a transparent protective film for polarizer (hereinafter this may be referred to as cellulose acylate). It is to be noted that, in the description, the term “cellulose acylate film” means a film containing cellulose acylate as a main ingredient.

The cellulose acylate film which can be used in the invention will be described in detail.

### Cellulose Acylate:

One typical example of cellulose acylate is triacetyl cellulose. The cellulose material for cellulose acylate includes cotton liter and wood pulp (hardwood pulp, softwood pulp), and cellulose acylate obtained from any such cellulose material is usable herein. As the case may be, those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein.

The degree of substitution of cellulose acylate means the degree of acylation of three hydroxyl groups existing in the constitutive unit ((β)1,4-glycoside-bonding glucose) of cellulose. The degree of substitution (degree of acylation) may be computed by measuring the bonding fatty acid amount per the constitutive unit mass of cellulose. The determination may be carried out according to “ASTM D817-91”.

The cellulose acylate for use in forming the first and second optically-anisotropic layers in the invention is cellulose acetate having a degree of acetyl substitution of from 2.50 to 3.00. More preferably, the degree of acetyl substitution is from 2.70 to 2.97. And the cellulose acylate may have any acyl other than acetyl in place of or along with acetyl. Among these, cellulose acylates having at least one acyl selected from acetyl, propionyl and butyryl are preferable; and cellulose acylates having at least two acyls selected from acetyl, propionyl and butyryl are preferable. Two or more types of such cellulose acylates may be contained.

Preferably, the cellulose acylate has a mass-average degree of polymerization of from 350 to 800, more preferably from 370 to 600. Also preferably, the cellulose acylate for use in the invention has a number-average molecular weight of from 70000 to 230000, more preferably from 75000 to 230000, even more preferably from 78000 to 120000.

The cellulose acylate may be produced, using an acid anhydride or an acid chloride as the acylating agent for it. One most general production method for producing the cellulose acylate on an industrial scale comprises esterifying cellulose obtained from cotton linter, wood pulp or the like with a mixed organic acid component comprising an organic acid corresponding to an acetyl group and other acyl group (acetic acid, propionic acid, butyric acid) or its acid anhydride (acetic anhydride, propionic anhydride, butyric anhydride).

### Refractivity-Anisotropic Material

The optically anisotropic layer A of the retardation film of the invention contains at least one refractivity-anisotropic material. The optically anisotropic layer B contains at least one refractivity-anisotropic material in a ratio smaller than that in the optically anisotropic layer A, or does not contain it at all. In the former embodiment, the refractivity-anisotropic material in the optically anisotropic layers A and B may be the same or different from each other. From the viewpoint of the recyclability, preferably, the material is the same in the two layers.

The refractivity-anisotropic material may be divided into two: one is a material of which the wavelength dispersion characteristics of refractivity anisotropy are “regular wavelength dispersion characteristics”, and the other is a material of which the wavelength dispersion characteristics of refractivity anisotropy are “reversed wavelength dispersion characteristics”. In the invention, any of those two types of refractivity-anisotropic materials are employable irrespective of the wavelength dispersion characteristics of the refractivity anisotropy thereof. “Reversed wavelength dispersion material” and “regular wavelength dispersion material” are defined here. As a control film, a stretched film of polymer alone with no wavelength dispersion characteristics of Re is prepared, or that is, a control film satisfying 0.99<Re(450)/Re(550)<1.01 is prepared. Apart from this, a sample film produced under the same condition as that for the control film except for addition of a certain material thereto is prepared. In case where the sample film exhibits reversed wavelength dispersion characteristics of Re, the material added to the film is a “reversed wavelength dispersion material”; but when the sample film exhibits regular wavelength dispersion characteristics of Re, then the material added to the film is a “regular wavelength dispersion material”. In case where the control film is a cellulose acylate film or the like that exhibits reversed wavelength dispersion characteristics of Re when stretched, the sample film produced under the same condition as that of the control film except for addition of a certain material thereto may be defined as follows: When the reversed wavelength dispersion of Re of the sample film is larger than that of the control film, then the material added to the sample film is a “reversed wavelength dispersion film”, but when the reversed wavelength dispersion of Re of the sample film is smaller than that of the control film, then the material added to the sample film is a “regular wavelength dispersion film”. In case where the control film is a film having regular wavelength dispersion characteristics of Re, the material added to the same film could be known as to whether it is a “reversed wavelength dispersion material” or a “regular wavelength dispersion material” in the same manner as above. The condition where “the reversed wavelength dispersion of retardation is larger” means that the value of Δn(550)/Δn(450) is larger by at least 0.01; and the condition where “the regular wavelength dispersion of retardation is larger” means that the value of Δn(550)/Δn(450) is smaller by at least 0.01.

Examples of the refractivity-anisotropic material include reversed wavelength dispersion materials such as the compounds represented by formula (A). The compounds represented by formula (A) preferably shows liquid-crystallinity.

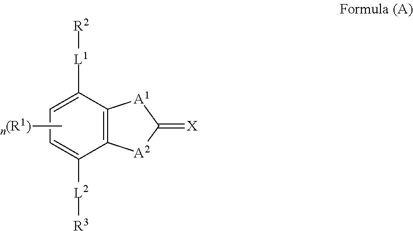

In the formula, L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

Among these, the compounds represented by formula (B) are preferable.

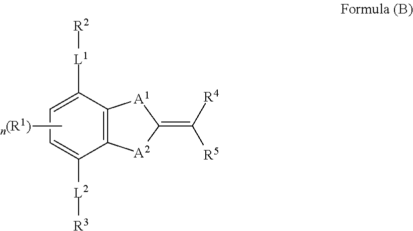

In the formula (B), L¹ and L² independently represent a single bond or a divalent group. A¹ and A² independently represent a group selected from the group consisting of —O—, —NR— where R represents a hydrogen atom or a substituent, —S— and —CO—. R¹, R², R³, R⁴ and R⁵ independently represent a substituent. And n is an integer from 0 to 2.

Preferred examples of the divalent linking group represented by L¹ or L² in the formula (A) or (B) include those shown below.

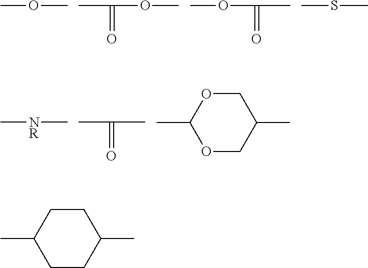

And further preferred are —O—, —COO— and —COO—.

In the formulae (λ) and (B), R¹ represents a substituent, if there are two or more R¹, they may be same or different from each other, or form a ring. Examples of the substituent include those shown below.

Halogen atoms such as fluorine, chlorine, bromine and iodine atoms; alkyls (preferably C₁₋₃₀ alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo [1,2,2]heptane-2-yl and bicyclo [2,2,2]octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo[2,2,1]hepto-2-en-1-yl and bicyclo[2,2,2]octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀ substituted or non-substituted aryloxy carbonyloxys) such as phenoxy carbonyloxy, p-methoxyphenoxy carbonyloxy and p-n-hexadecyloxyphenoxy carbonyloxy; aminos (preferably C_{O-30} substituted or non-substituted alkylaminos and C₅₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₅₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N—(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, an alkoxy group, an acyloxy group, cyano or an amino group; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵ independently represent a substituent. Examples of the substituent include those exemplified above as examples of R¹. Preferably, R⁴ and R⁵ independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity—Hammeto soku—Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)” on p. 217, published by TOKYO KAGAKU DOZIN CO. LTD., and written by Tadao Nakatani; and Chemical Reviews, Vol. 91, No. 2, pp. 165-195 (1991).

In the formula, A¹ and A² independently represent a group selected from the group consisting of —O—, —NR— where R represents a hydrogen atom or a substituent, —S— and —CO—; and preferably, —O—, —NR— where R represents a substituent selected from those exemplified above as examples of R¹, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (A) or (B) include, but examples of the Re enhancer are not limited to, those shown below. Regarding the compounds shown below, each compound to which is appended (X) is referred to as “Example Compound (X)” unless it is specified.

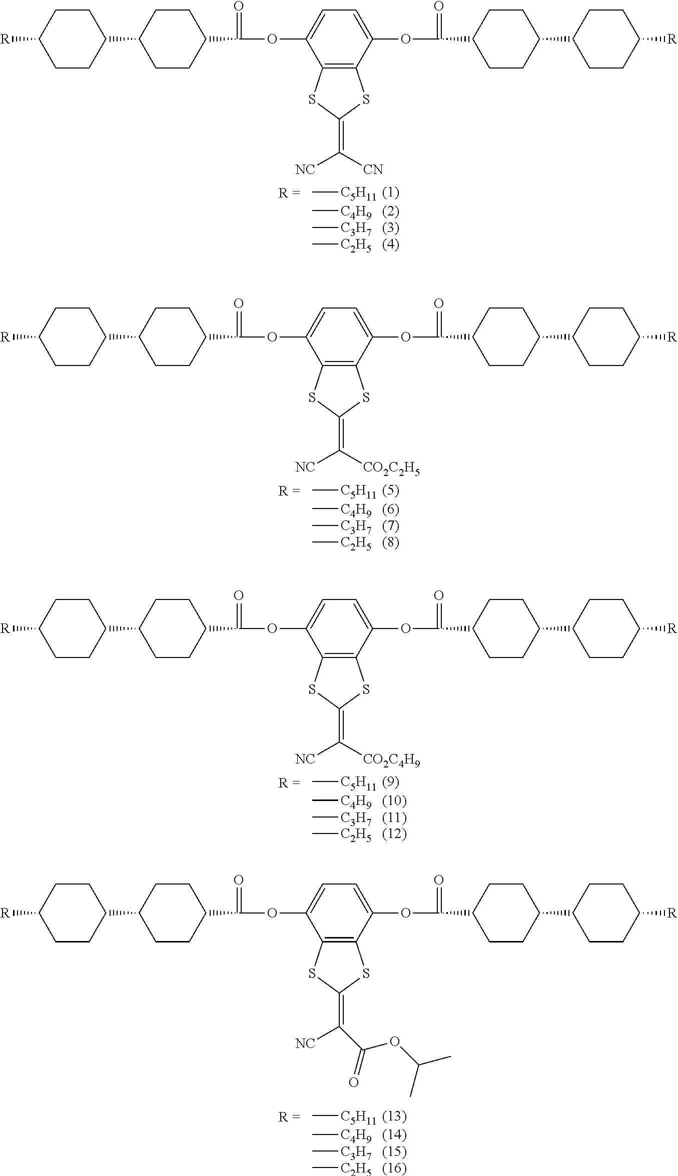

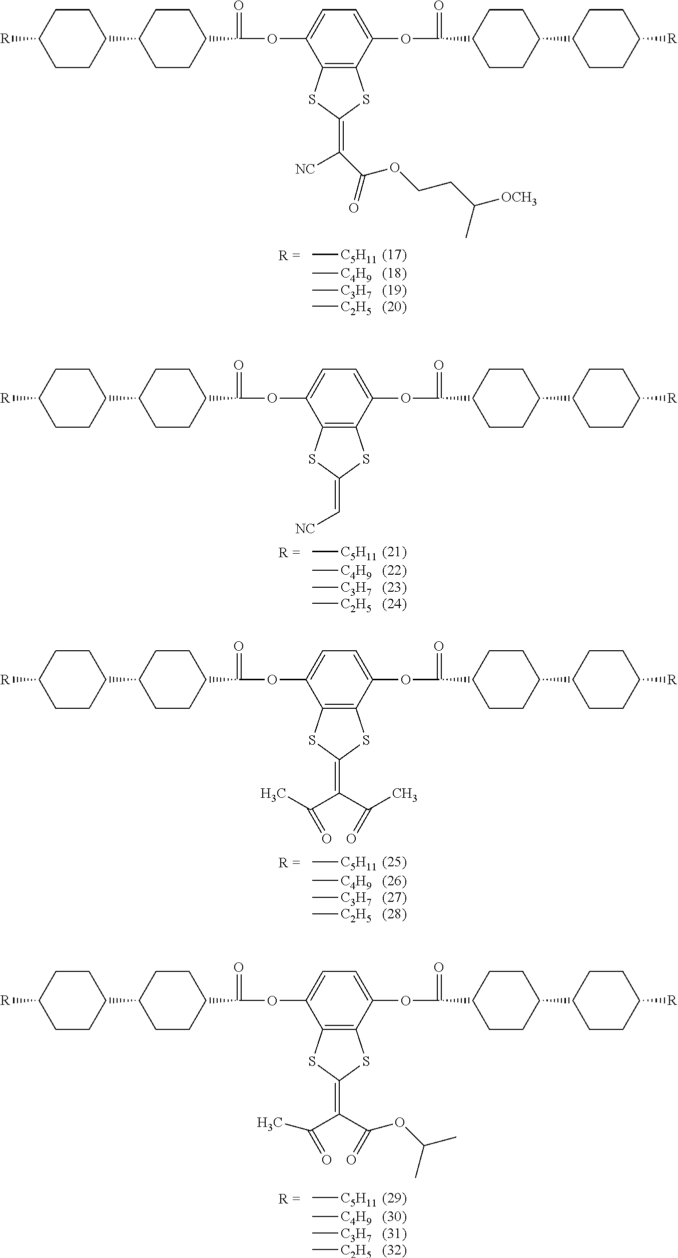

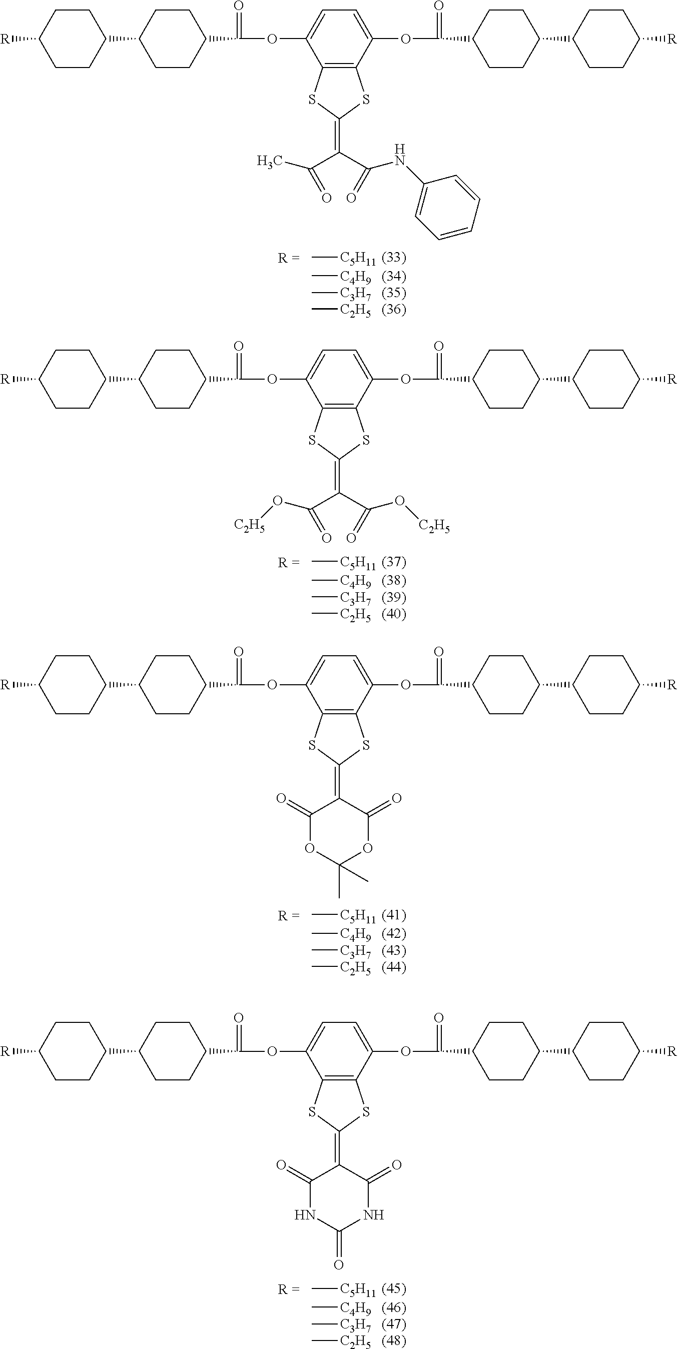

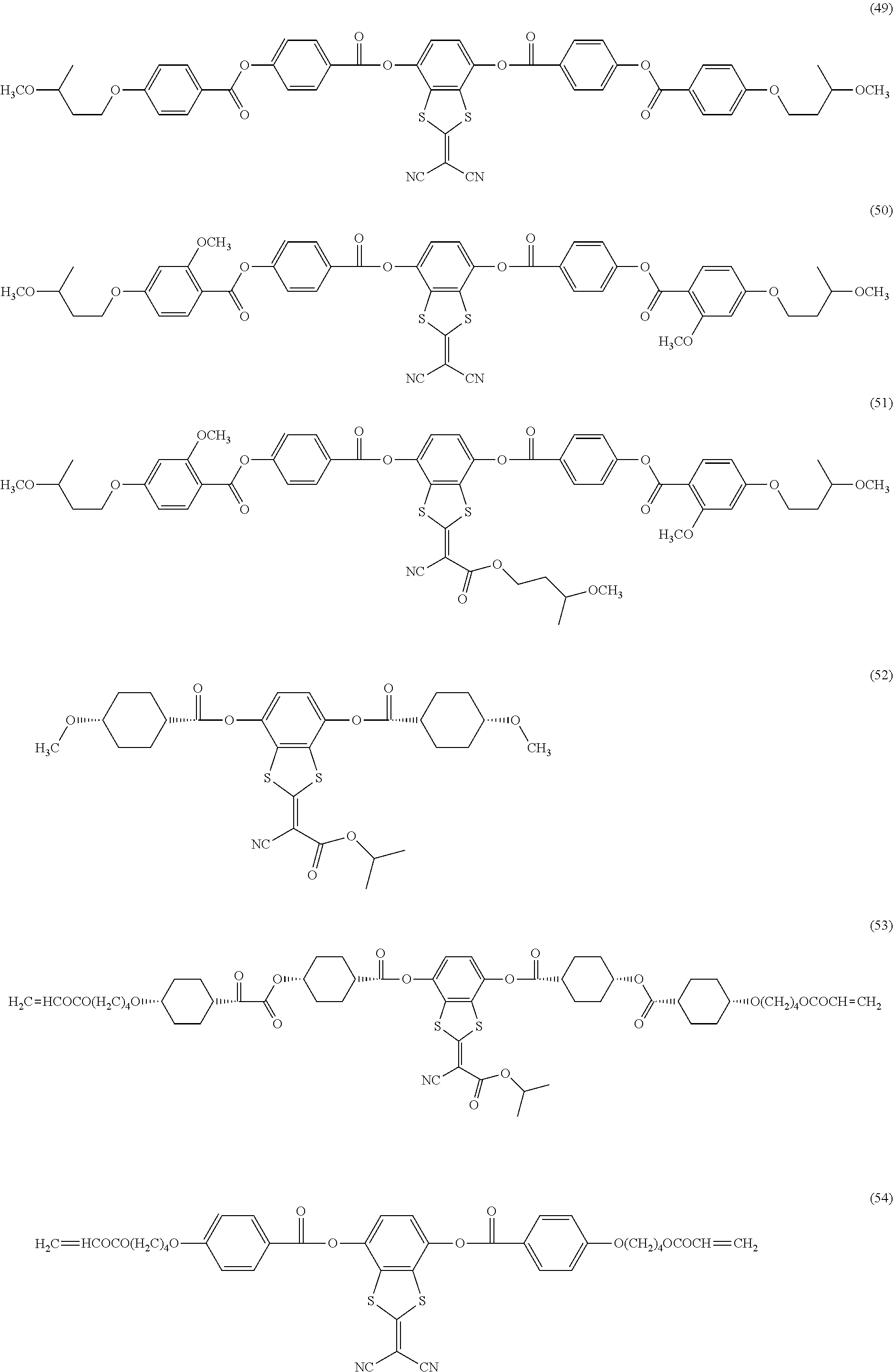

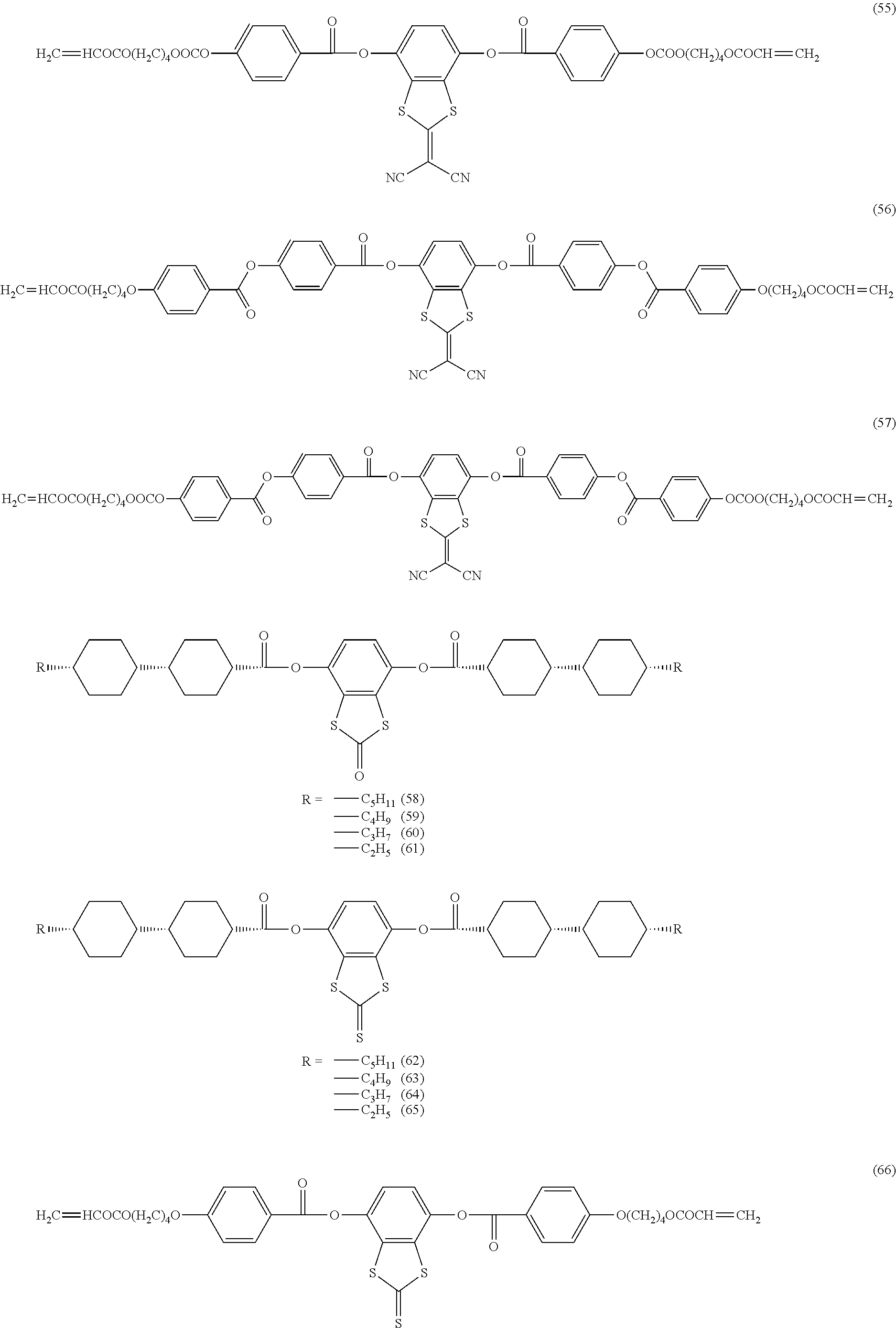

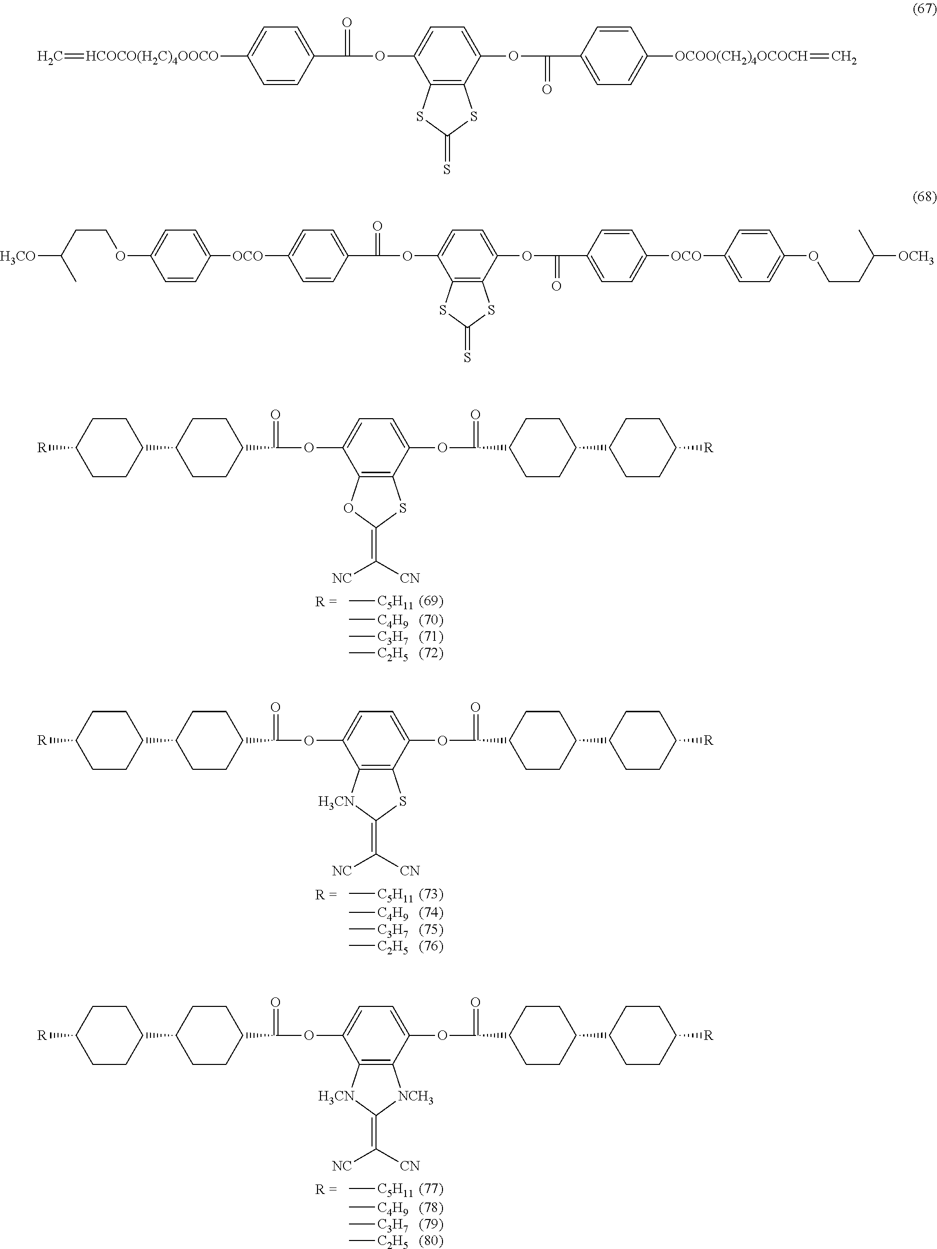

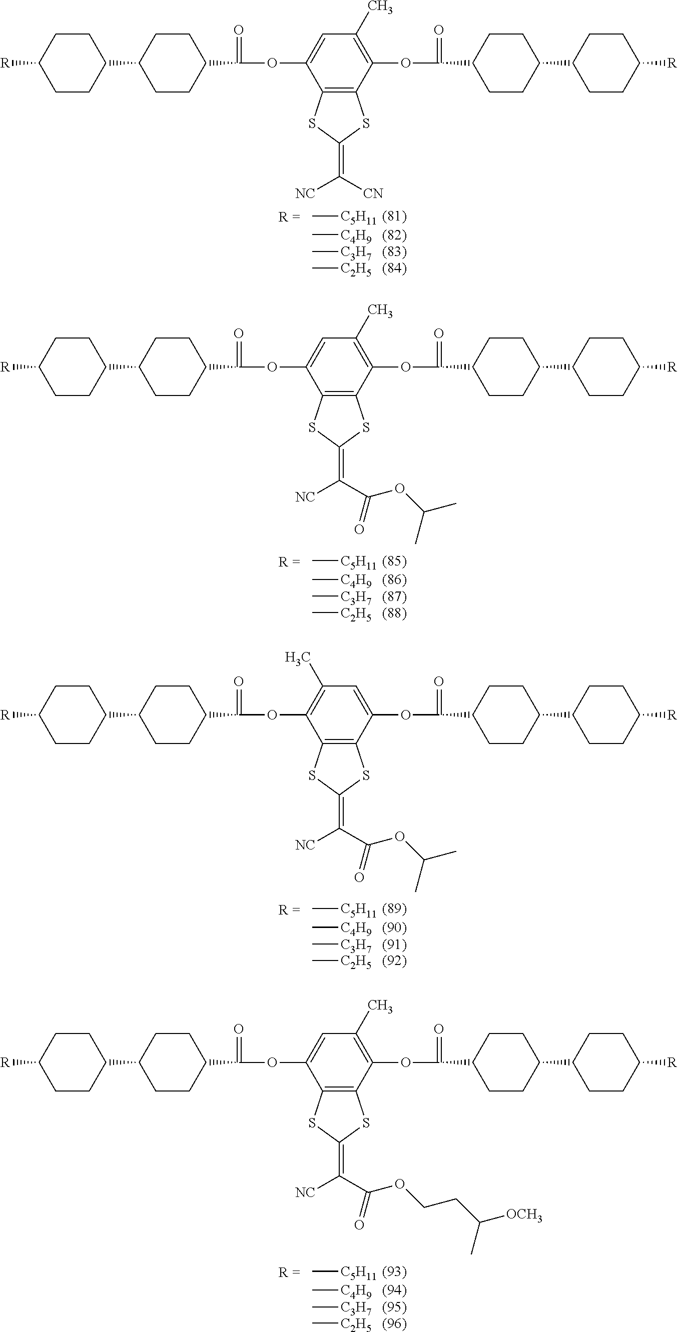

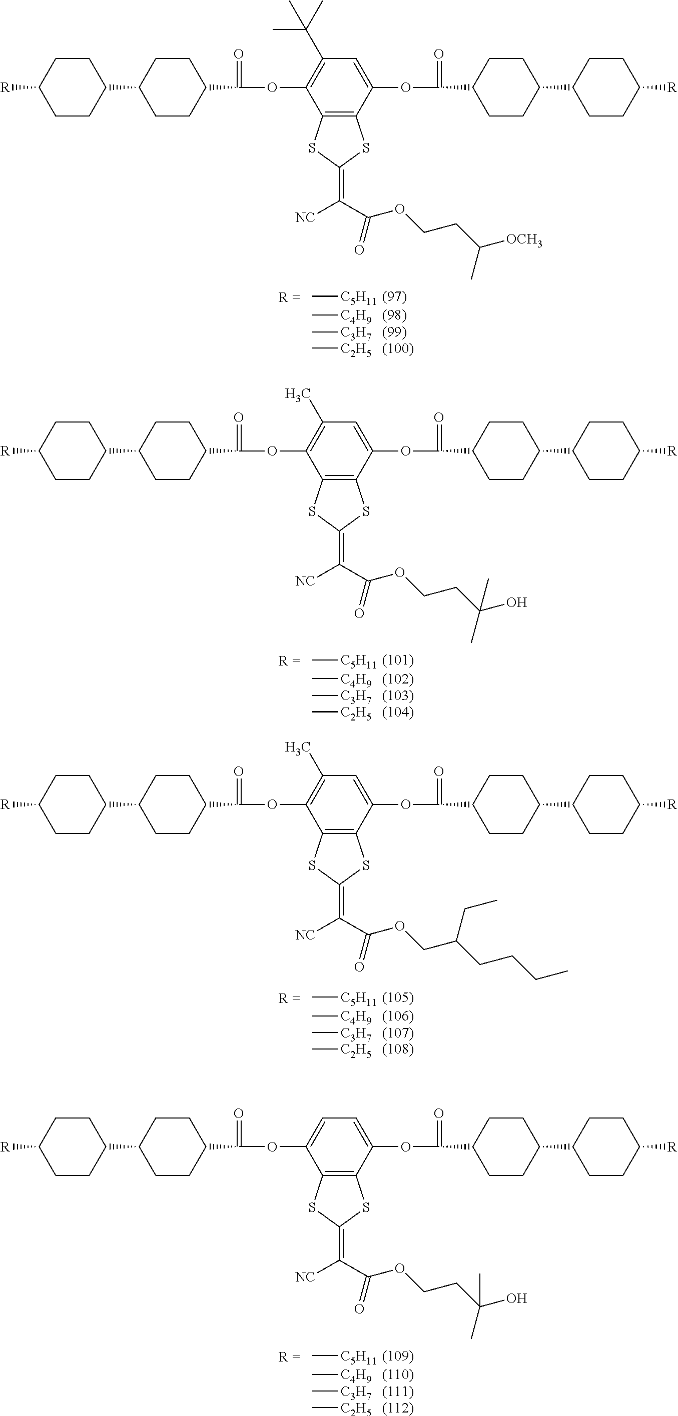

The compound represented by the formula (A) or (B) may be synthesized referring to known methods. For example, Example Compound (1) may be synthesized according to the following scheme.

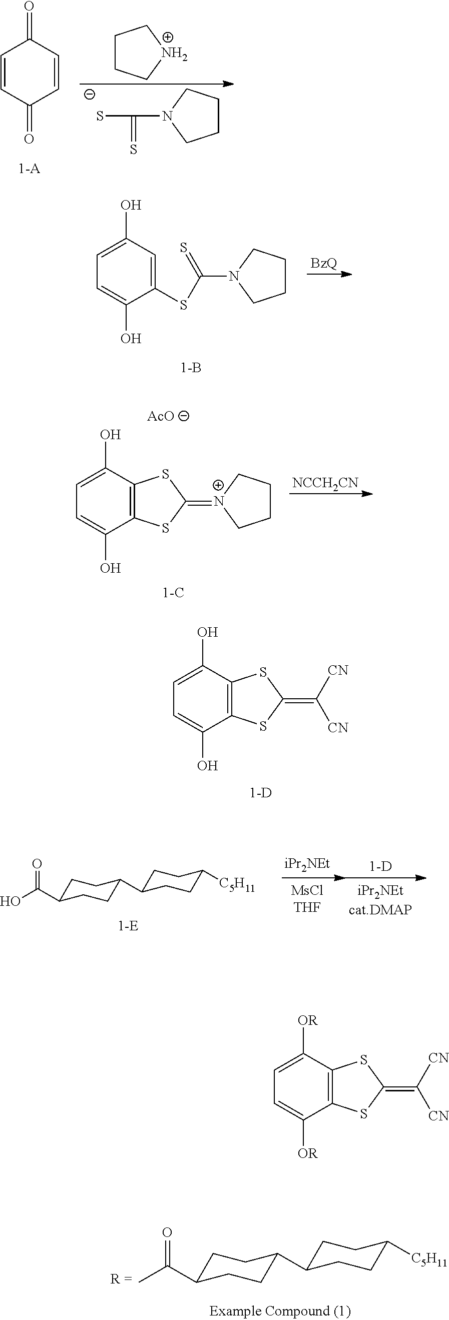

In the above scheme, the steps for producing Compound (1-d) from Compound (1-A) may be carried out referring to the description in “Journal of Chemical Crystallography” (1997); 27(9); p. 515-526.

As shown in the above scheme, Example Compound (1) may be produced as follows. A tetrahydrofuran solution of Compound (1-E) is added with methanesulfonic acid chloride, added dropwise with N,N-di-iso-propylethylamine and then stirred. After that, the reaction solution is added with N,N-di-iso-propylethylamine, added dropwise with a tetrahydrofuran of Compound (1-D), and then added dropwise with a tetrahydrofuran solution of N,N-dimethylamino pyridine (DMAP).

Examples of the refractivity-anisotropic material include regular wavelength dispersion materials such as the rod-like compounds represented by formula (a). The compounds represented by formula (a) preferably shows liquid-crystallinity. By using such a rod-like compound, it may be possible to align any liquid crystal compound more easily together with it in a cellulose acylate film, which may contribute to developing retardation. Furthermore, by using such a rod-like compound, it may be possible to dissolve any liquid crystal compound more easily in the film.

Ar¹-L¹²-X-L¹³-Ar² Formula (a)

In the formula (a), Ar¹ and Ar² independently represent an aromatic group; L¹² and L¹³ independently represent —O—CO— or —CO—O—; X represents 1,4-cyclohexylen, vinylene or ethynylene.

In the description, the term “aromatic group” is used for any substituted or non-substituted aryl (aromatic hydrocarbon) group and any substituted or non-substituted aromatic heterocyclic group.

Substituted or non-substituted aryl groups are preferred to substituted or non-substituted aromatic heterocyclic group. A hetero ring in the aromatic heterocyclic group is generally unsaturated. Preferably, the aromatic hetero ring is selected from 5-, 6- and 7-membered rings; and more preferably 5- and 6-membered rings. An aromatic hetero ring generally has the maximum number of double bonds. Preferred examples of the hetero atom embedded in the hetero ring include nitrogen, oxygen and sulfur atoms; and more preferred examples include nitrogen and sulfur atoms.

Examples of the aromatic ring in the aromatic group include benzene, furan, thiophene, pyrrole, oxazole, thiazole, imidazole, triazole, pyridine, pyrimidine and pyrazine rings; and among these, a benzene ring is especially preferred.

Examples of the substituent, that the substituted aryl group and the substituted aromatic heterocyclic group have, include halogen atoms (e.g., F, Cl, Br, and I), hydroxyl, carboxyl, cyano, amino, alkylaminos (e.g., methylamino, ethylamino, butylamino and dimethylamino), nitro, sulfo, carbamoyl, alkylcarbamoyls (e.g., N-methylcarbamoyl, N-ethylcarbamoyl, and N,N-dimethylcarbamoyl), sulfamoyl, alkylsulfamoyls (e.g., N-methylsulfamoyl, N-ethylsulfamoyl, and N,N-dimethylsulfamyl), ureido, alkylureidos (e.g., N-methylureido, N,N-dimethylureido, and N,N,N′-trimethyl ureido), alkyls (e.g., methyl, ethyl, propyl, butyl, pentyl, heptyl, octyl, isopropyl, s-butyl, t-amyl, cyclohexy, and cyclopentyl), alkenyls (e.g., vinyl, allyl, and hexenyl), alkynyls (e.g., ethynyl and butynyl), acyls (e.g., formyl, acetyl, butyryl, hexanoyl and lauryl), acyloxys (e.g., acetoxy, butyryloxy, hexanoyloxy, and lauryloxy), alkoxys (e.g., methoxy, ethoxy, propoxy, butoxy, pentyloxy, heptyloxy, and octyloxy), aryloxys (e.g., phenoxy), alkoxycarbonyls (e.g., methoxycarbonyl, ethoxycarbonyl, propoxycarbonyl, butoxycarbonyl, pentyloxycarbonyl, and heptyloxycarbonyl), aryloxycarbonyls (e.g., phenoxycarbonyl), alkoxycarbonylaminos (e.g., butoxycarbonylamino, and hexylcarbonylamino), alkylthios (e.g., methylthio, ethylthio, propylthio, butylthio, pentylthio, heptylthio and octylthio), arylthios (e.g., phenylthio), alkylsulfonyl (e.g., methylsulfonyl, ethylsulfonyl, propylsulfonyl, butylsulfonyl, pentylsulfonyl, heptylsulfonyl, and octylsulfonyl), amidos (e.g., acetamido, butylamido, hexylamido, and laurylamido), and non-aromatic hetero ring residues (e.g., morpholino, and pyridyl).

Among these, halogen atoms, cyano, carboxyl, hydroxyl, amino, alkyl-substituted aminos, acyls, acyloxys, amidos, alkoxycarbonyls, alkoxys, alkylthios and alkyls are preferred.

The alkyl moiety in the alkyl amino, alkoxycarbonyl, alkoxy or alkylthio may have at least one substituent, Examples of the substituent in the alkyl moieties or in the alkyls include halogen atoms, hydroxyl, carboxyl, cyano, amino, alkylaminos, nitro, sulfo, carbamoyl, alkylcarbamoyls, sulfamoyl, alkylsulfamoyls, ureido, alkylureidos, alkenyls, alkynyls, acyls, acyloxys, acylaminos, alkoxys, aryloxys, alkoxycarbonyls, aryloxycarbonyls, alkoxycarbonylaminos, alkylthios, arylthios, alkylsulfonyls, amidos and non-aromatic hetero ring residues. Among these, halogen atoms, aminos, alkylaminos, alkoxycarbonyls and alkoxys are preferred.

In the formula (a), L¹² and L¹³ independently represent —O—CO—or —CO—O—.

In the formula (a), X represents 1,4-cyclohexylen, vinylene or ethynylene.

Examples of the compound represented by the formula (a) include, but are not limited to, those shown below.

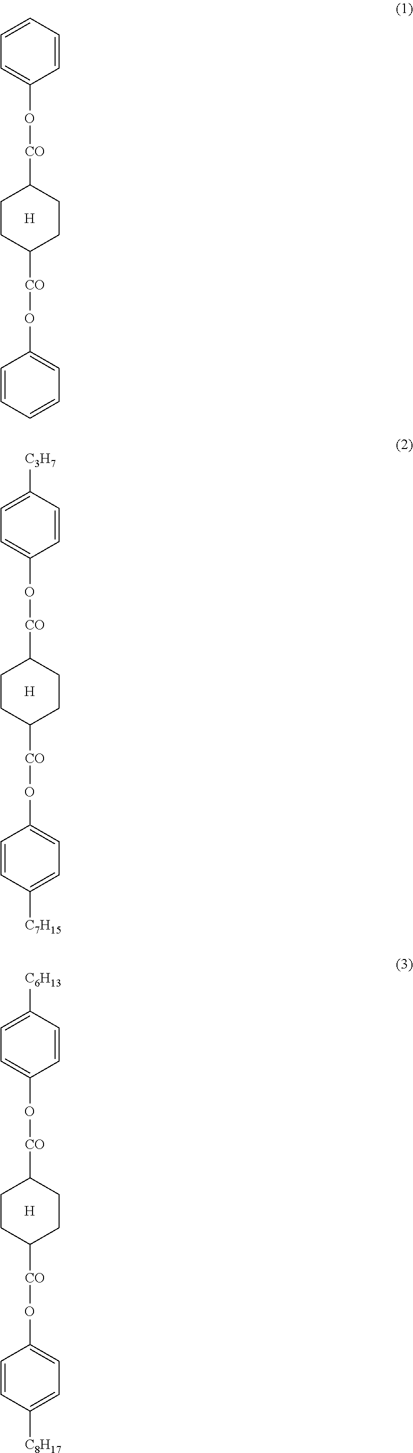

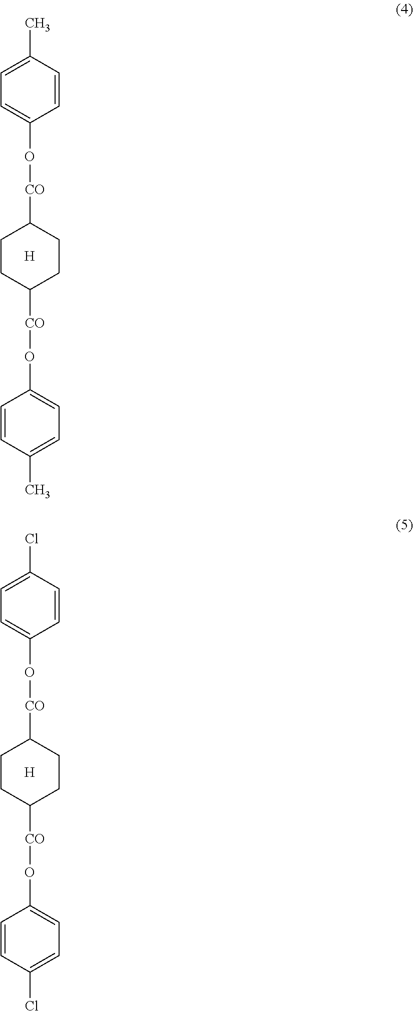

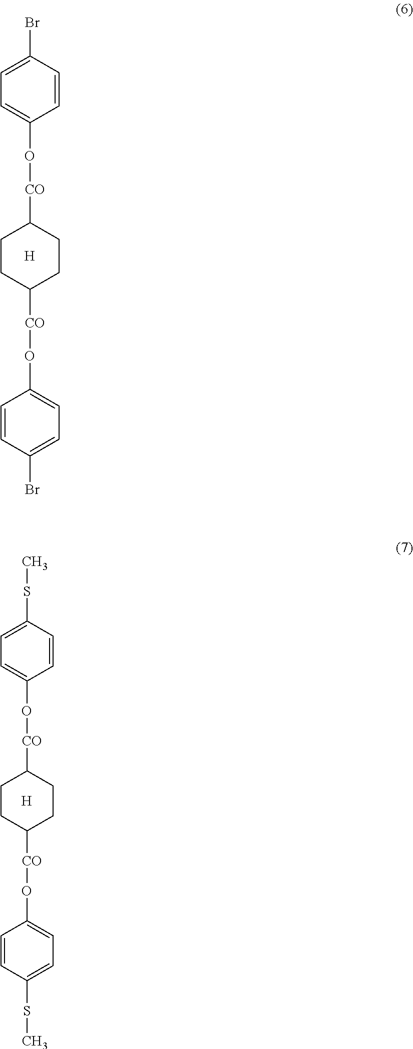

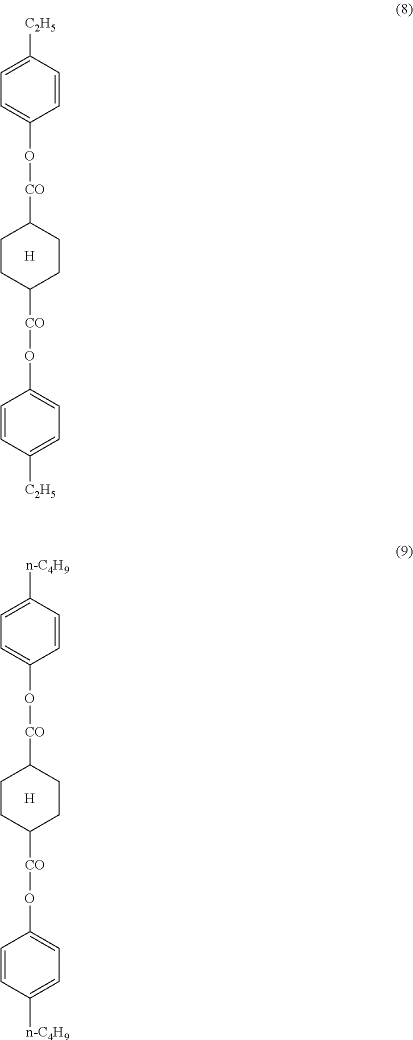

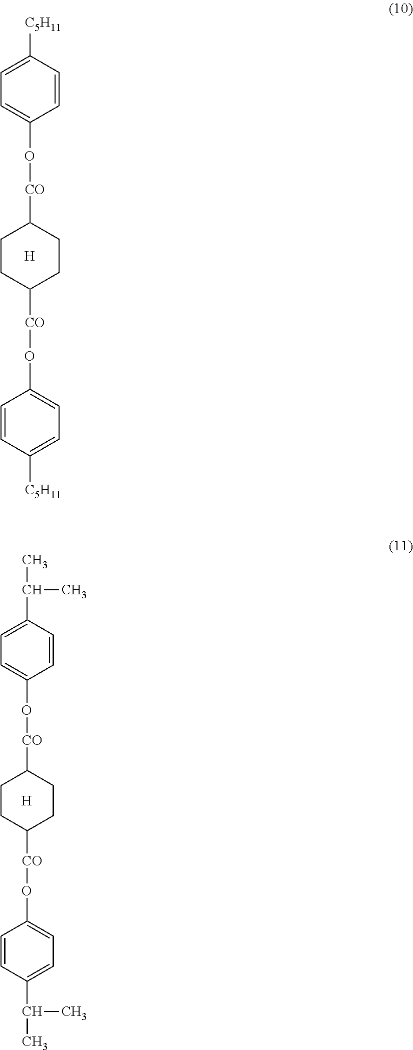

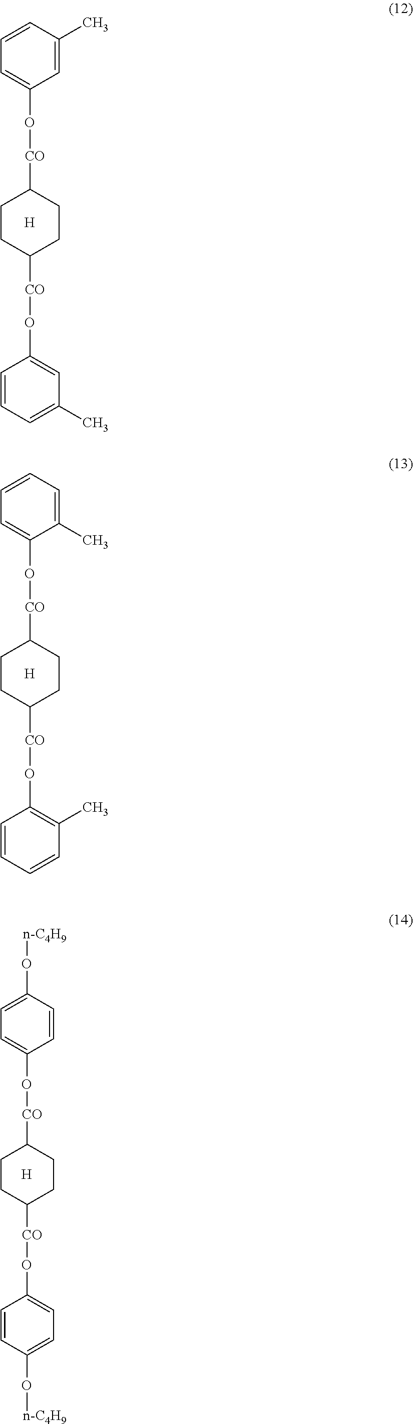

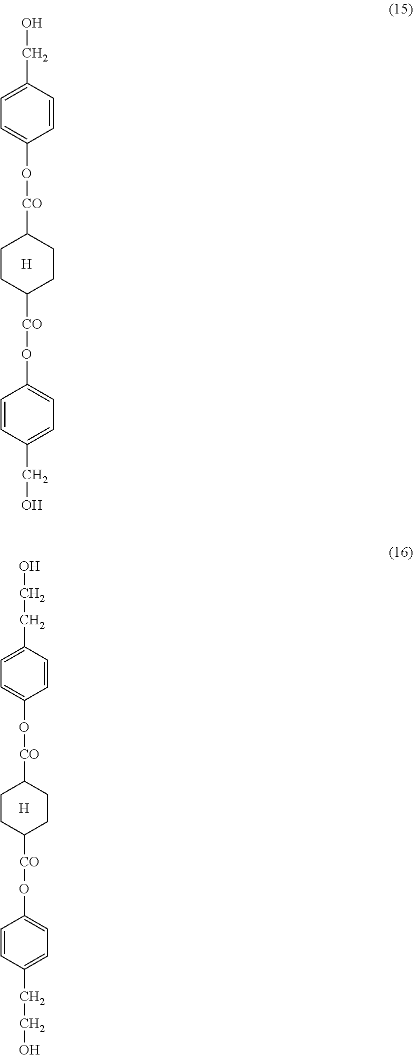

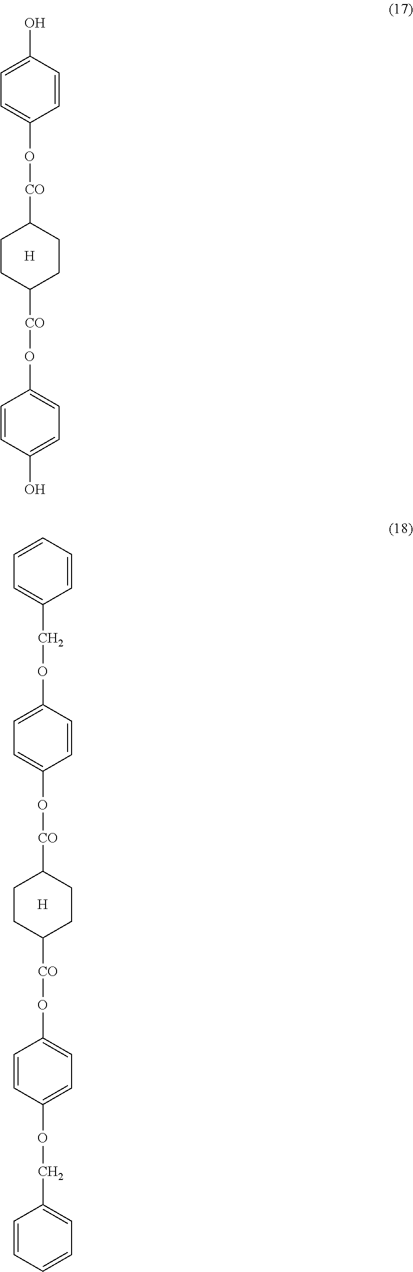

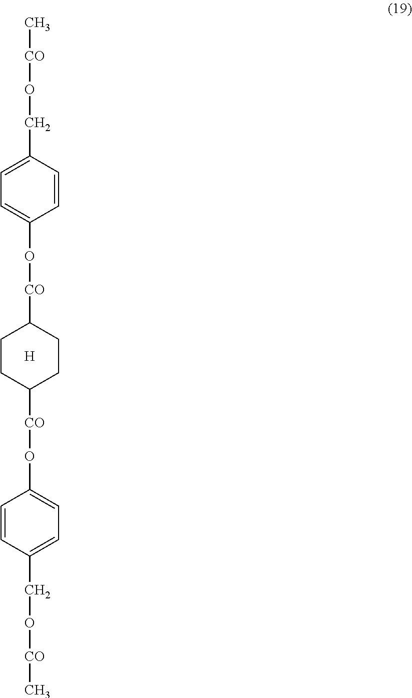

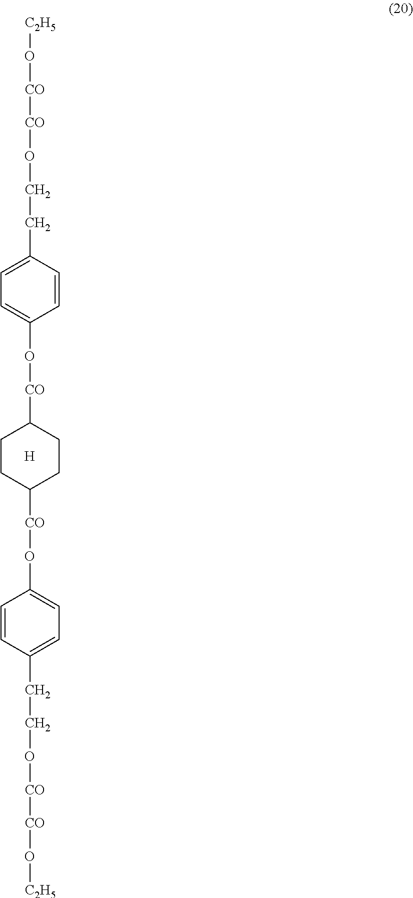

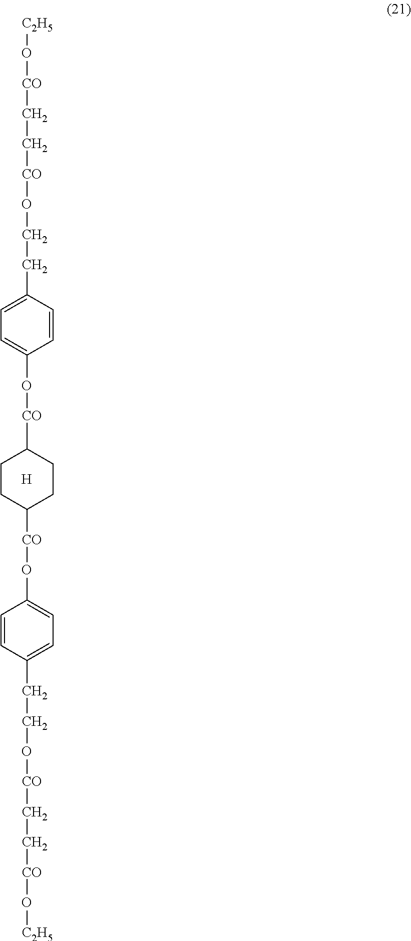

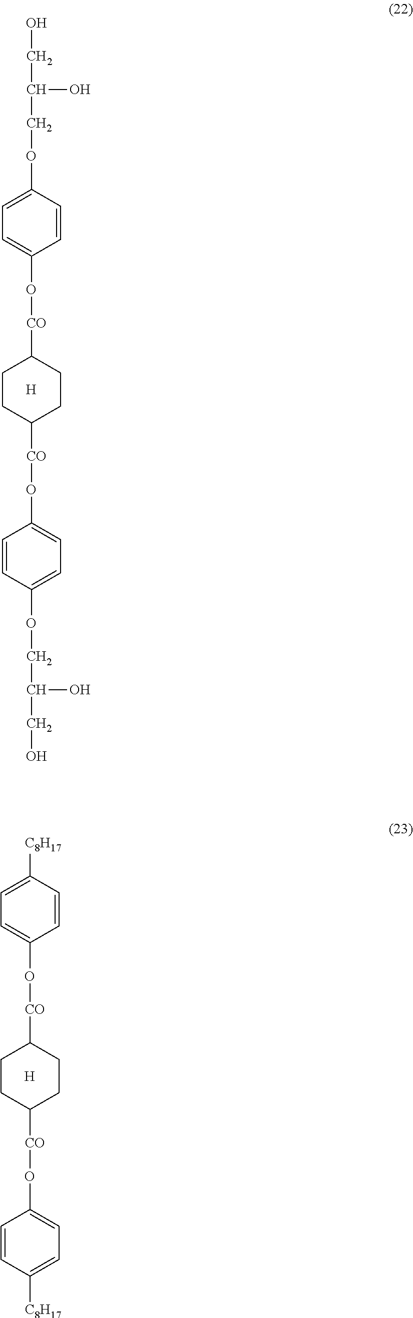

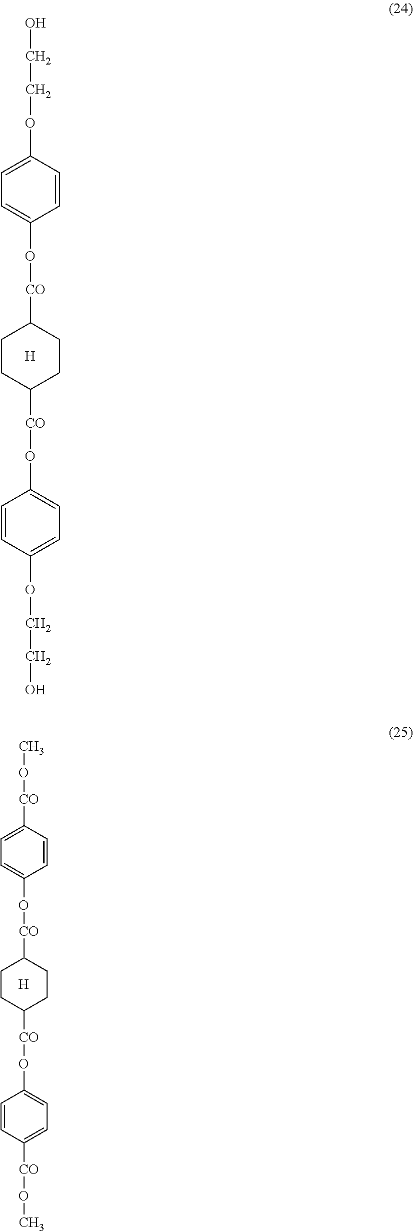

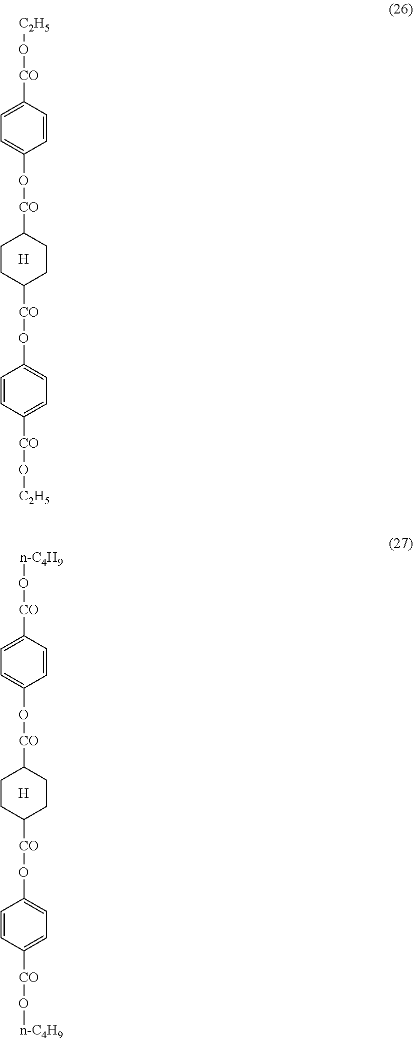

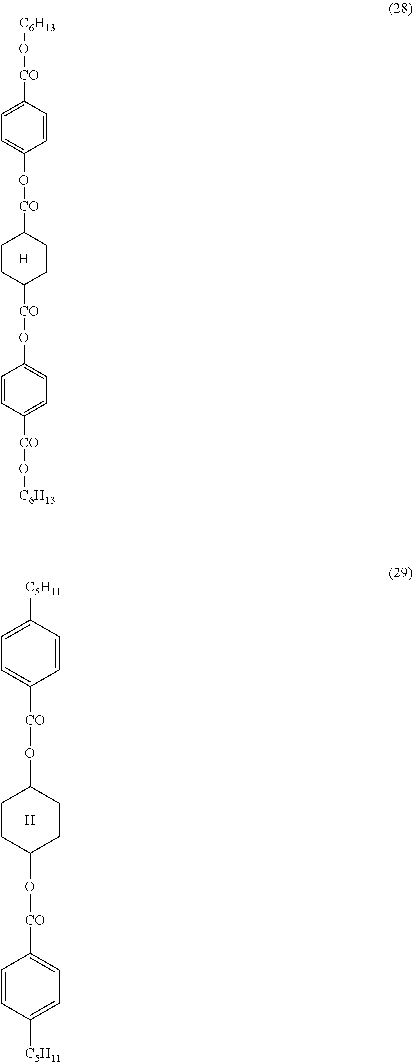

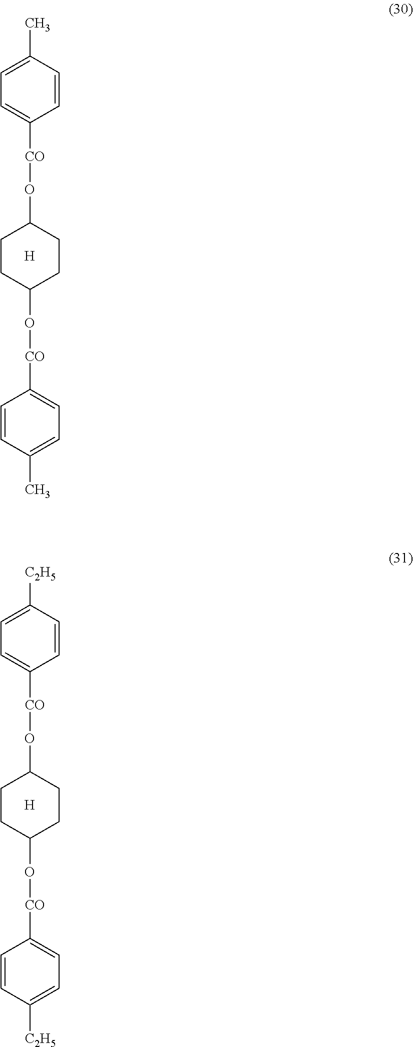

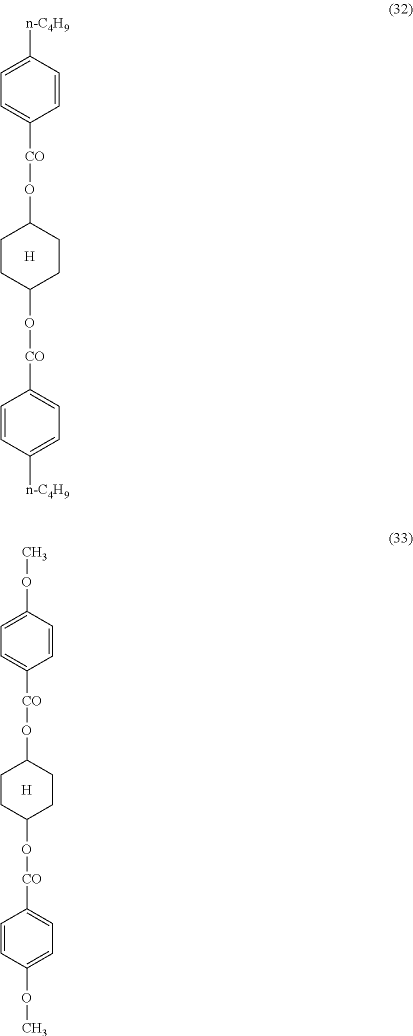

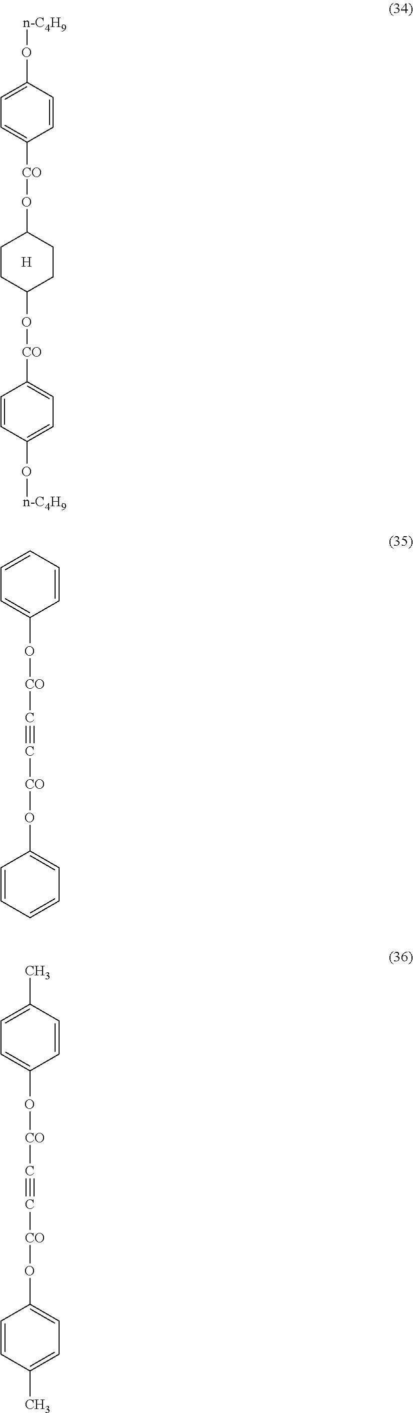

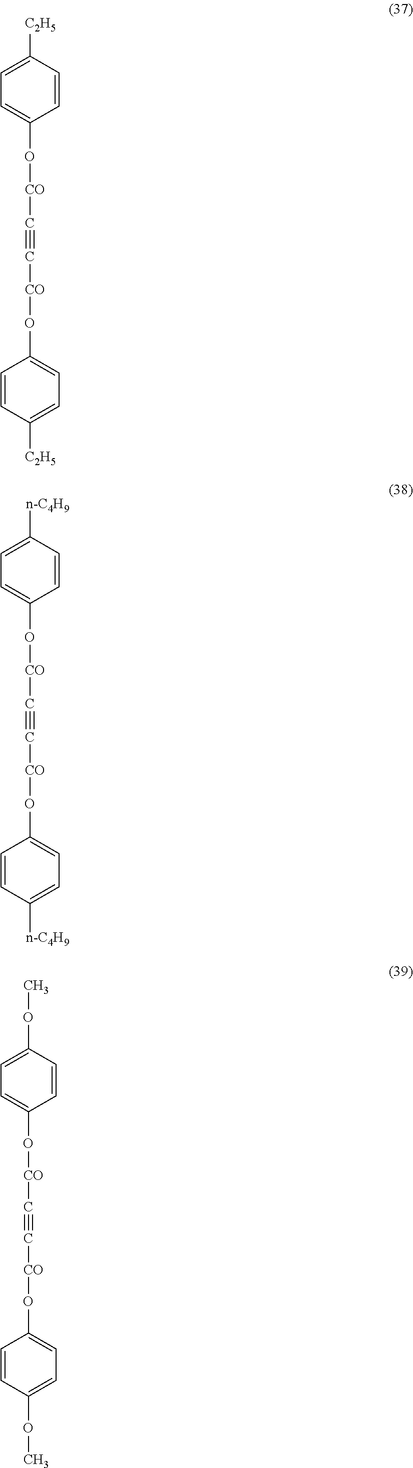

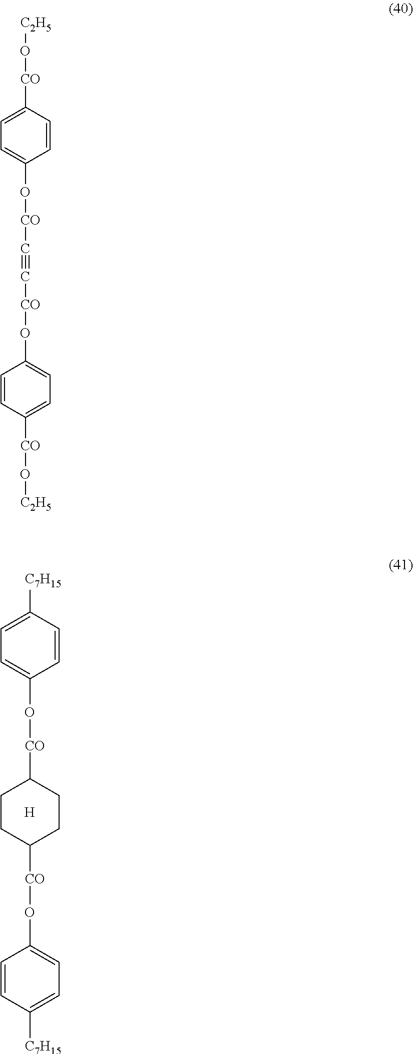

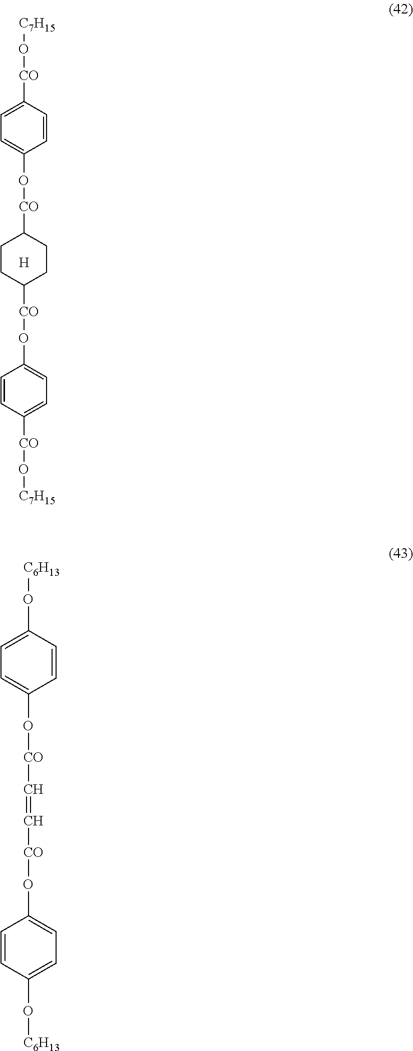

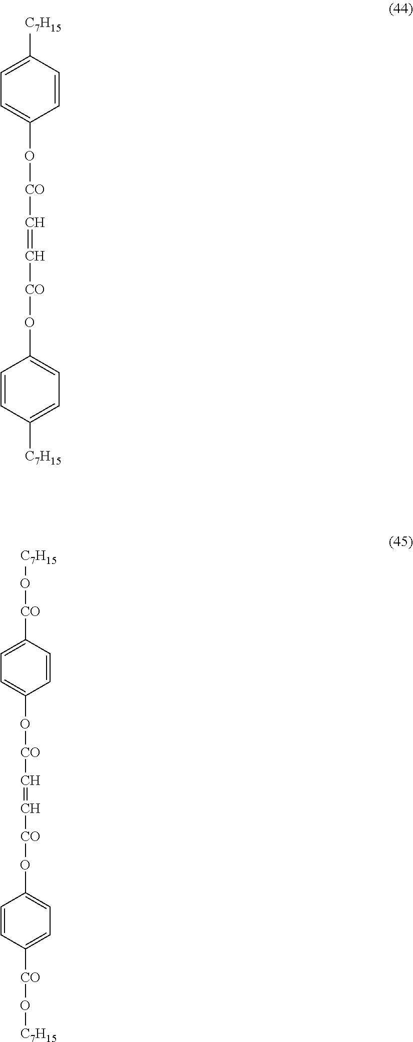

The example compounds (1) to (34), (41) and (42) have two asymmetric carbon atoms in the 1- and 4-positions in the cyclohexane ring, however it is noted that their molecular structures are meso-type structures and symmetric. Therefore, there is no enantiomer thereof, and are only geometric isomers, trans and cis types thereof. Of the example compound (1), the trans (1-trans) and cis (1-cis) types are shown below.

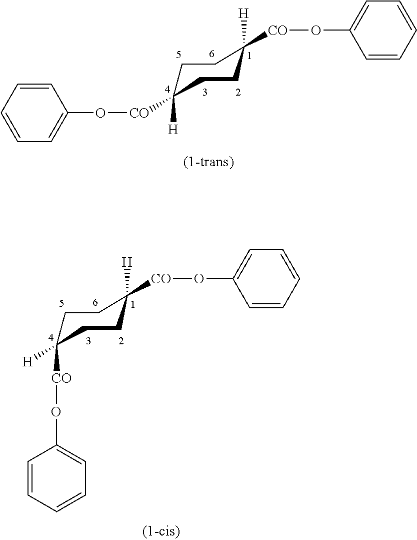

As described above, preferably, the molecular structures of the rod-like compounds are linear. Therefore, trans types are preferred to cis types.

Addition to the geometric isomers, there are enantiomers of the example compound (2) and (3), and the total number of the isomers is four. Among the geometric isomers, trans types are preferred to the cis types. And among the enantiomers, they are nearly equal, and D-, L- and racemic bodies are used equally.

There are trans and cis types as a center of the vinylene bond of the example compounds (43) to (45). On the same reason as above, the trans types are preferred to the cis types.

Examples of the refractivity-anisotropic material include regular wavelength dispersion materials such as the compounds represented by formula (I).

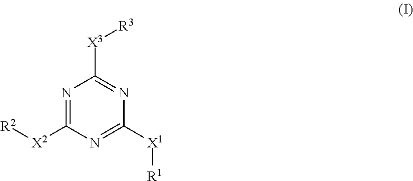

In the formula, X¹ represents a single bond, —NR⁴—, —O— or —S—; X² represents a single bond, —NR⁵—, —O— or —S—; X³ represents a single bond, —NR⁶—, —O— or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, 1-(1) to IV-(10), of the compound represented by the formula (I) include, but are not limited to, those shown below.

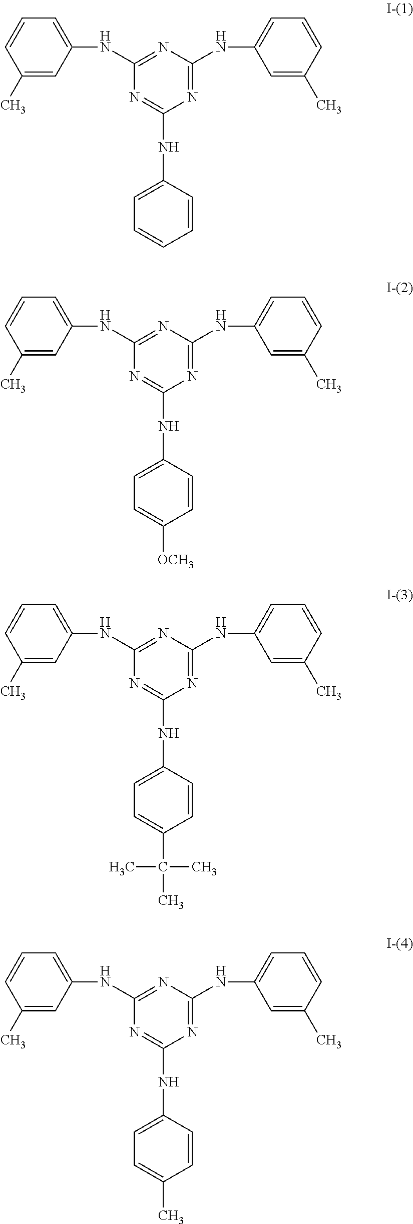

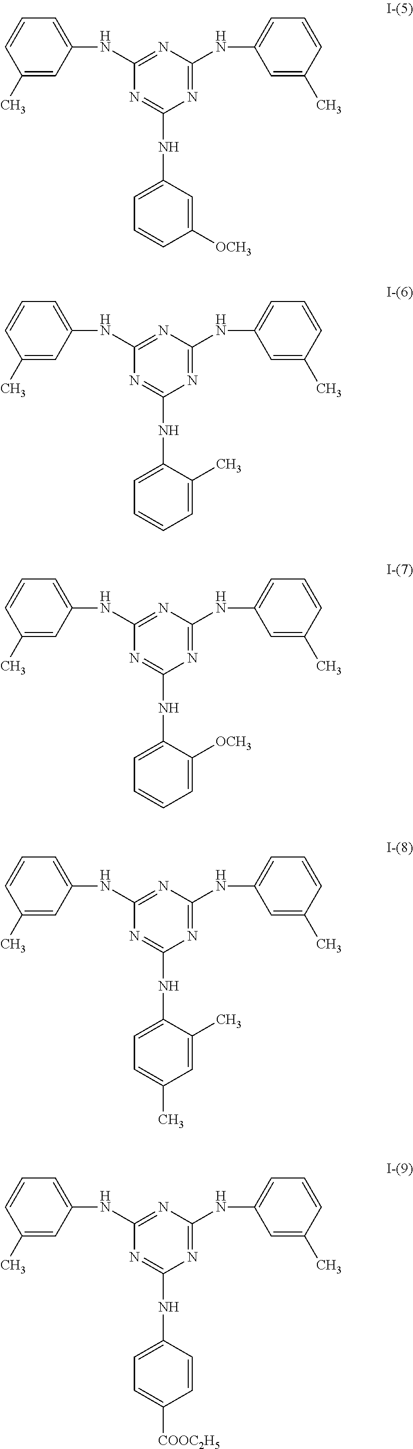

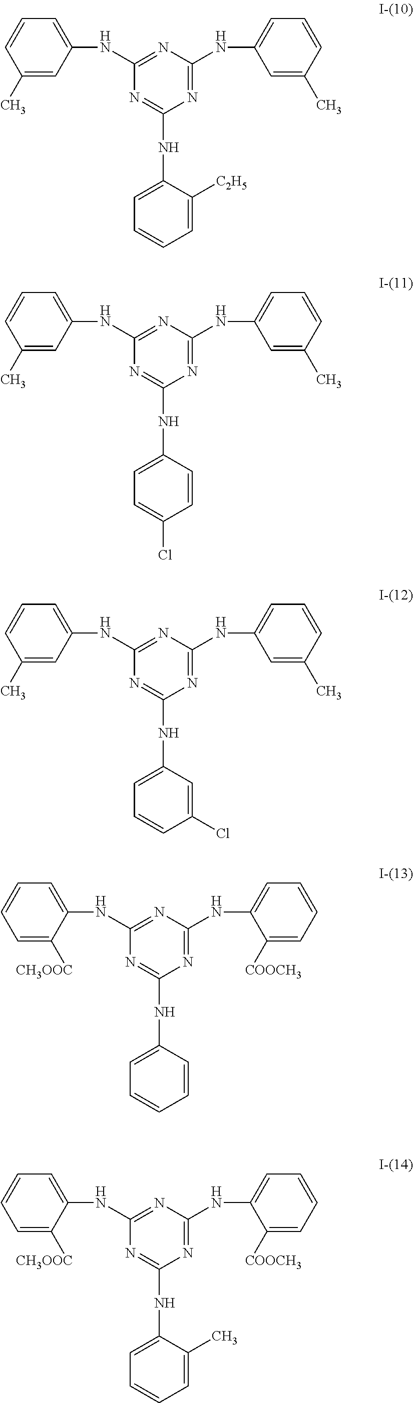

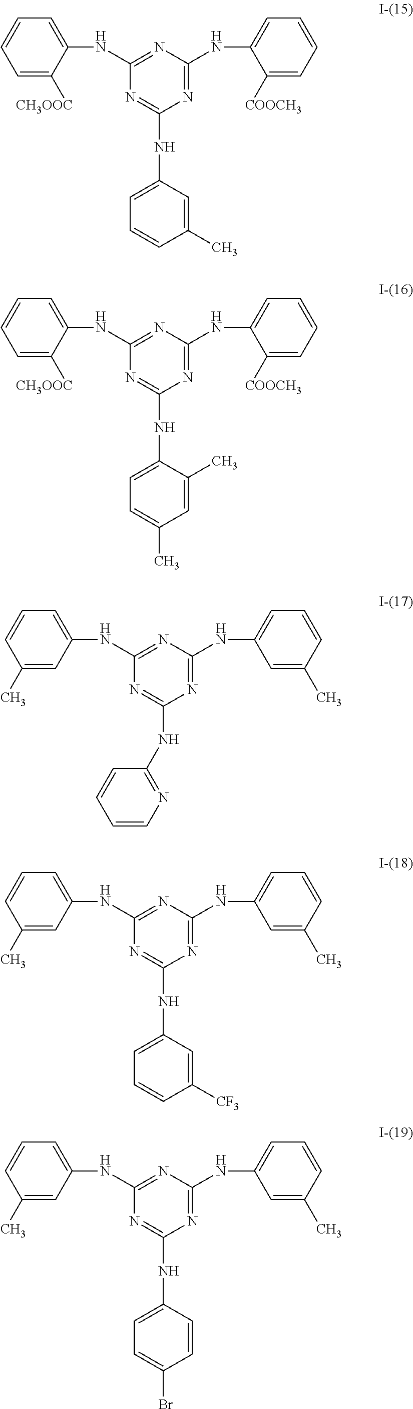

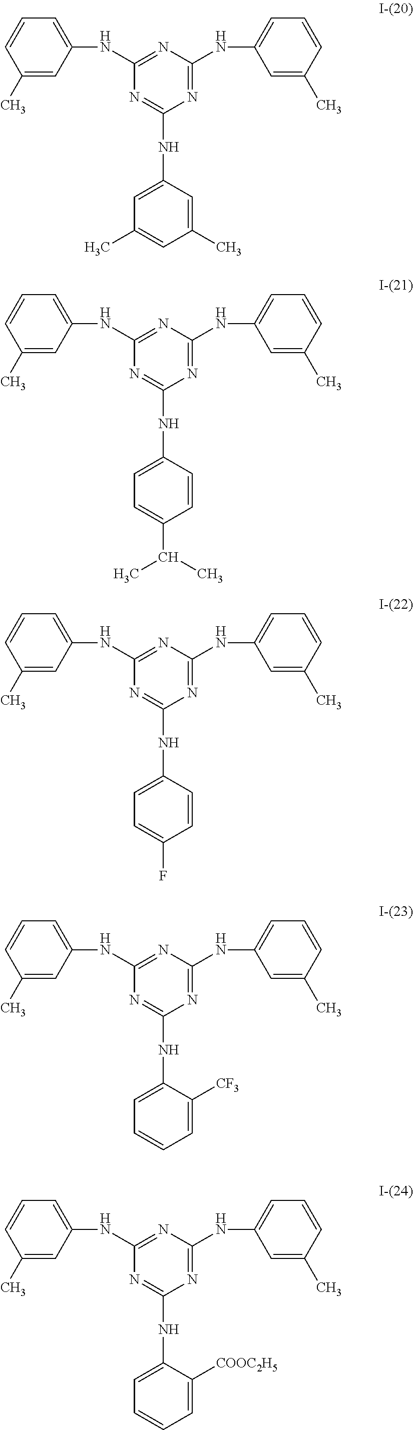

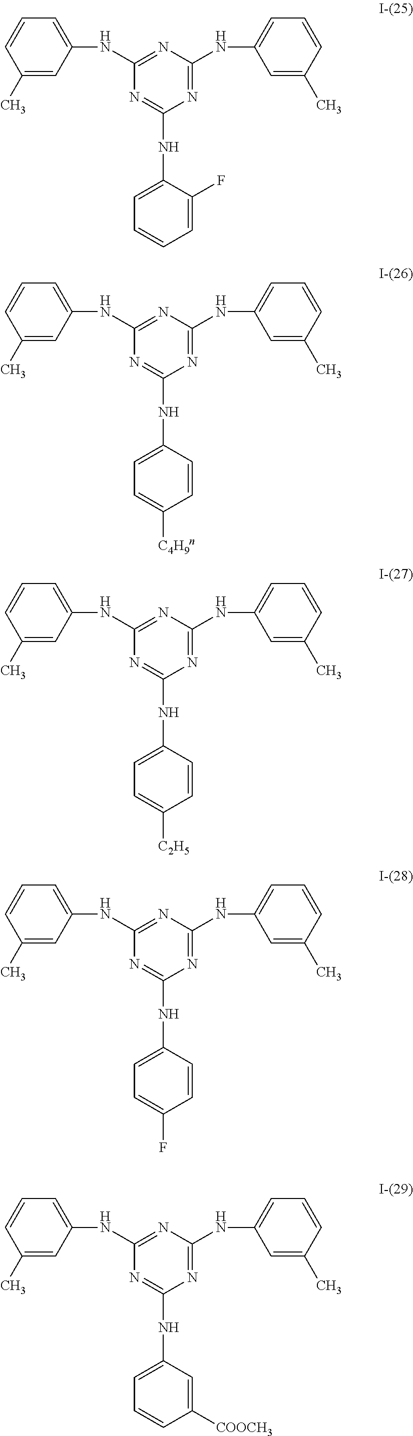

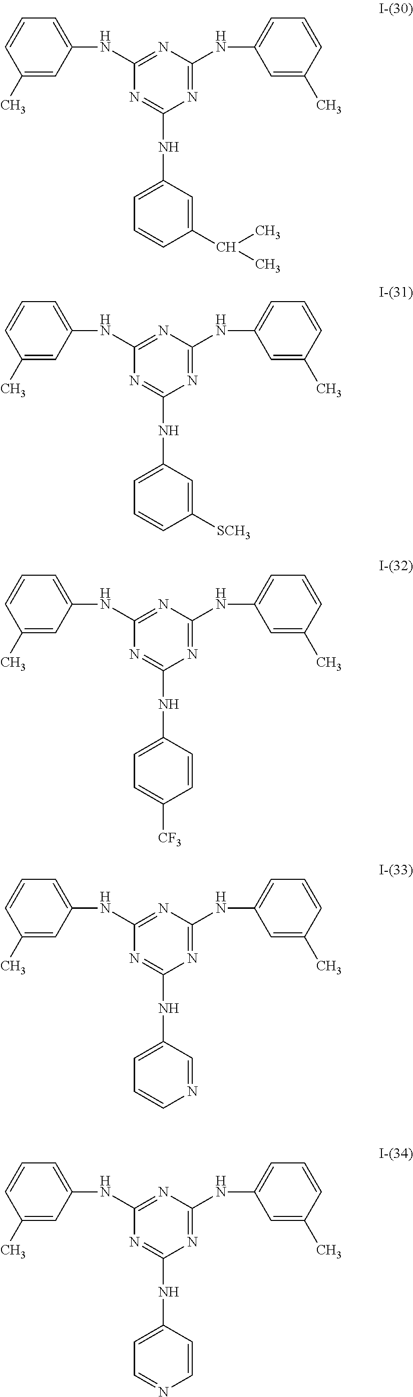

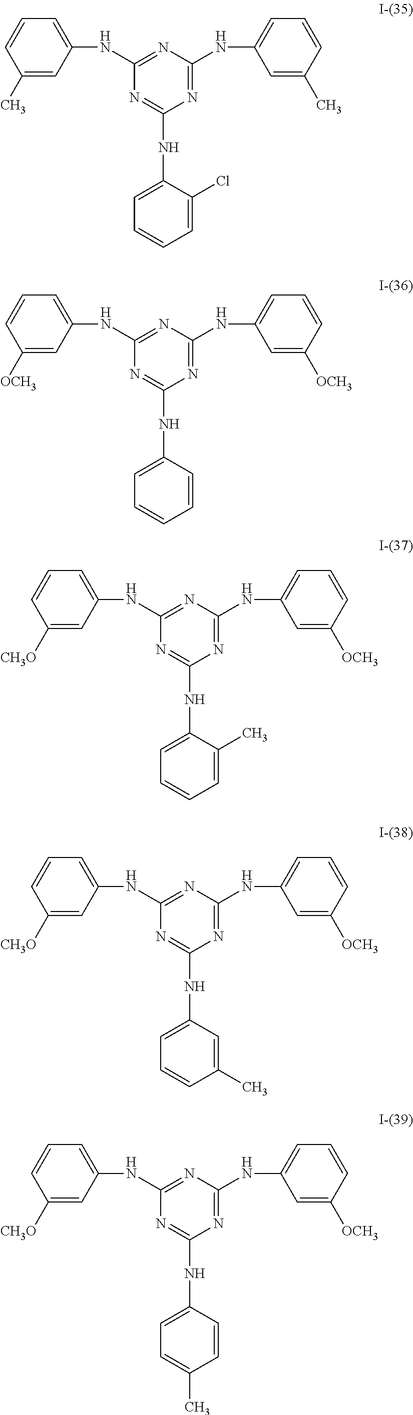

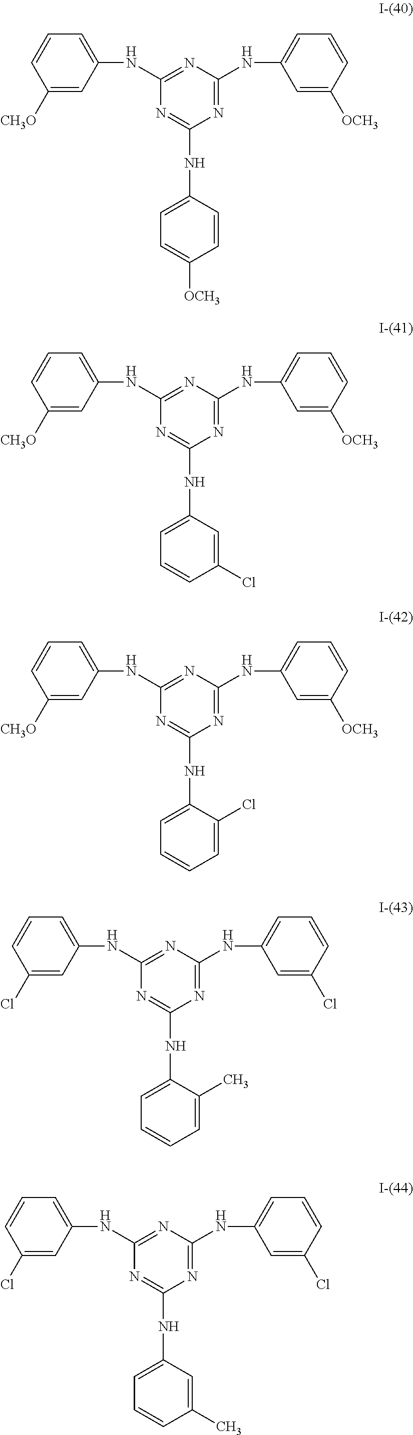

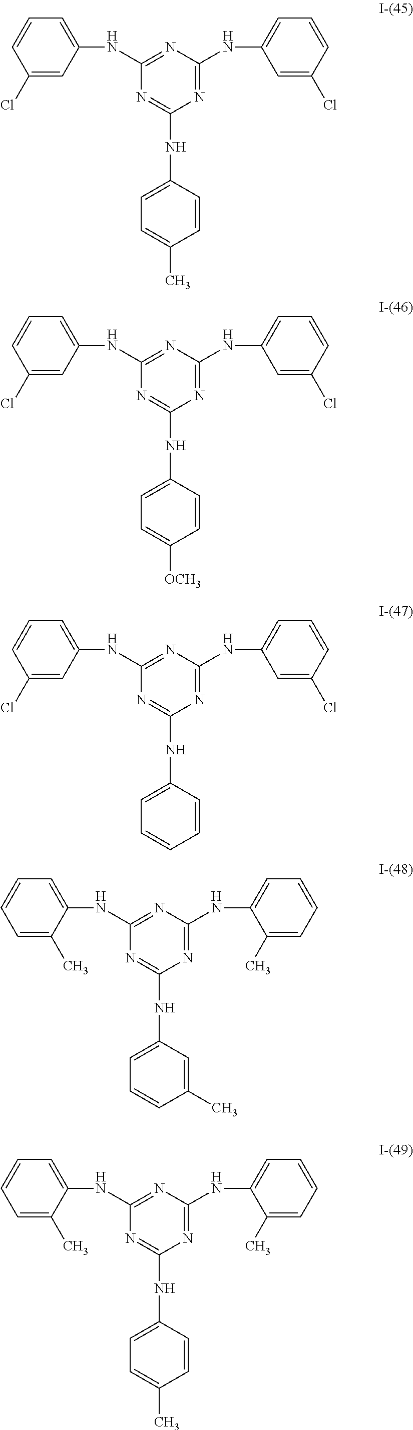

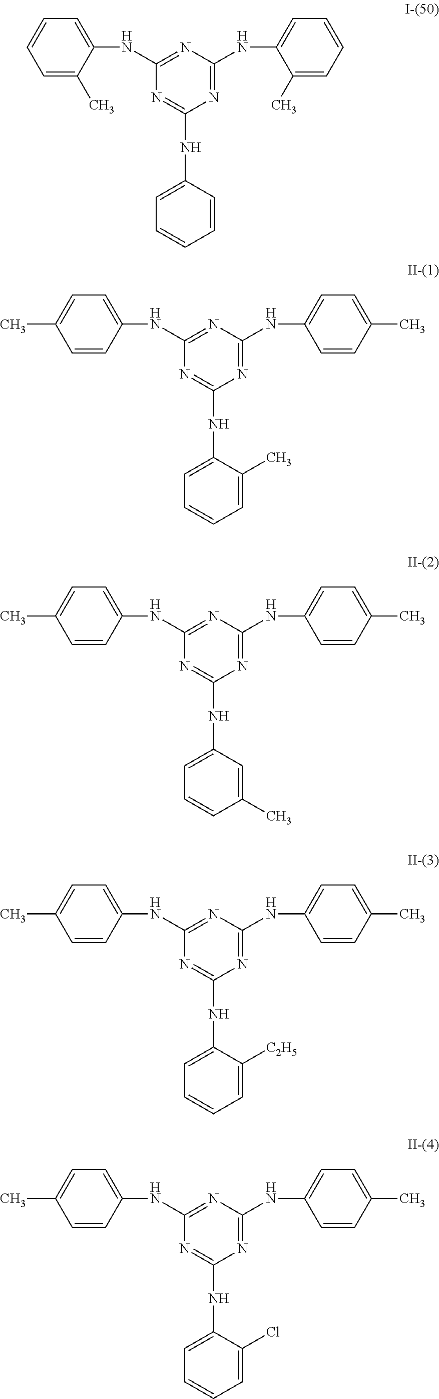

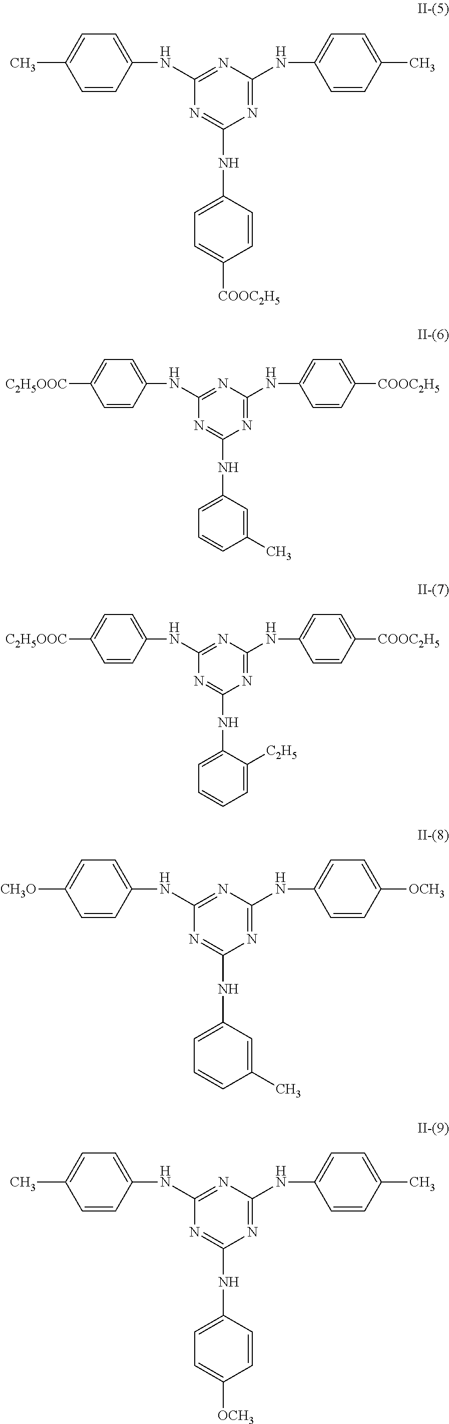

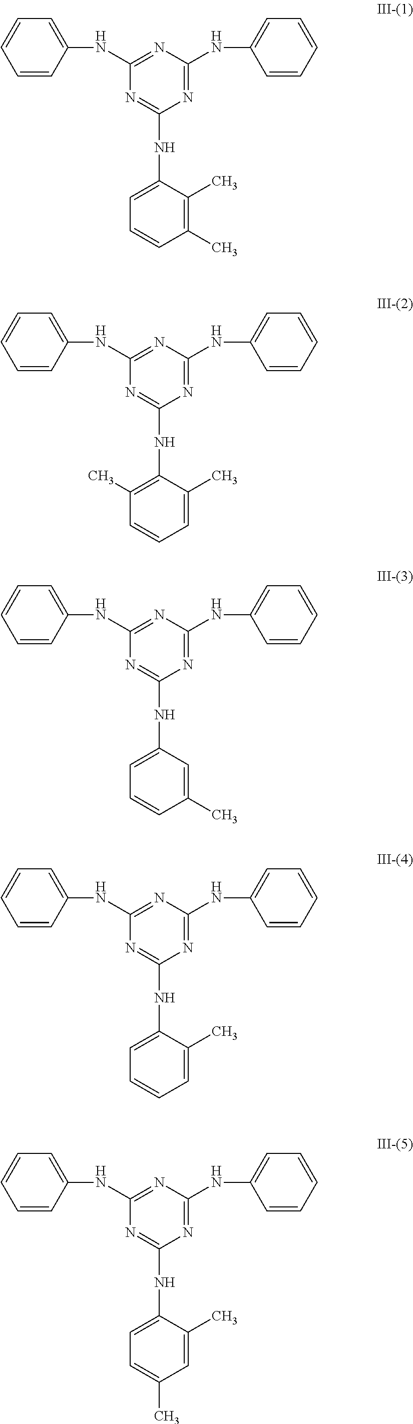

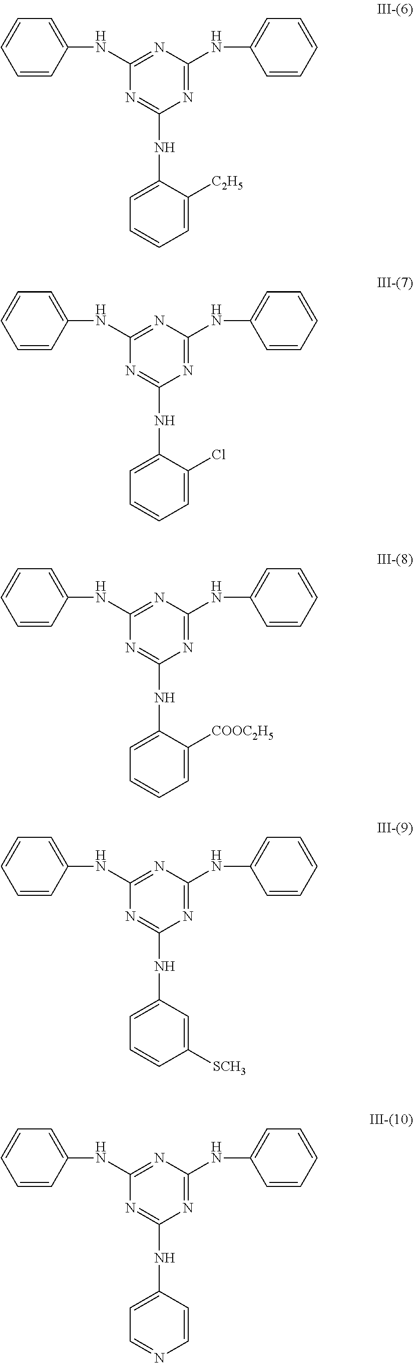

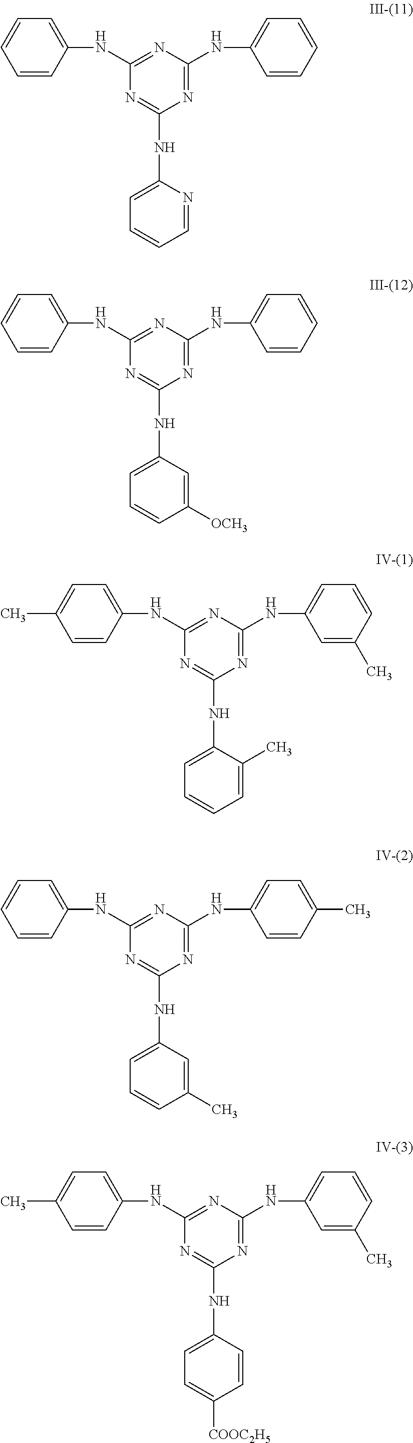

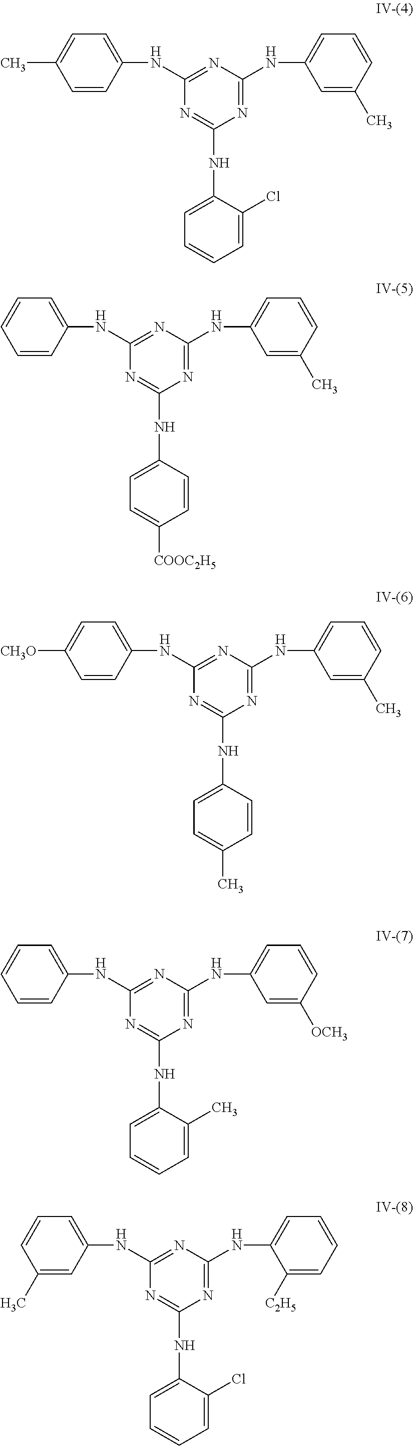

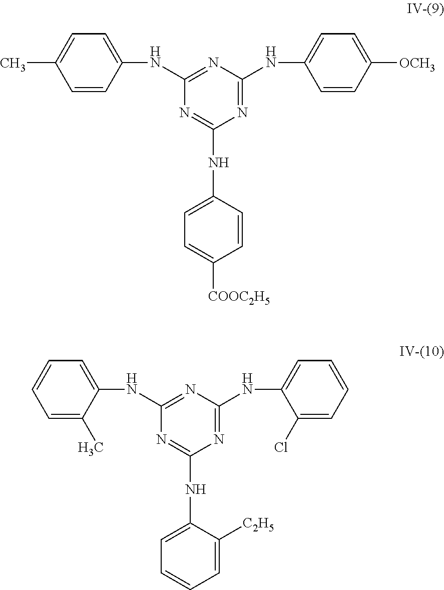

Preferably, the optically anisotropic layer A contains at least one refractivity-anisotropic material in an amount of from 1 to 20% by mass of the polymer A therein, more preferably from 1 to 10% by mass, even more preferably from 3 to 10% by mass. However, the content should not be limited to the range.

On the other hand, on the presumption that the proportion of at least one refractivity-anisotropic material in the optically anisotropic layer B is smaller than that in the optically anisotropic layer A, the layer B preferably contains at least one refractivity-anisotropic material in an amount of from 0 to 10% by mass of the polymer B therein, more preferably from 0 to 7% by mass, even more preferably from 0 to 5% by mass. However, the content should not be limited to the range.

A plasticizer may be added to the retardation film of the invention for the purpose of improving the mechanical properties of the film or increasing the drying speed thereof. As the plasticizer, usable are phosphates or carboxylates. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetyl citrate (OACTE) and tributyl O-acetylcitrate (OACTB). Examples of other carboxylates include butyl oleate, methylacetyl ricinoleate, dibutyl sebacate, various trimellitates, etc. The phthalate-type plasticizers (DMP, DEP, DBP, DOP, DPP, DEHP) are preferably used here. DEP and DPP are especially preferred.

Other examples of plasticizer usable here include saccharide derivatives from glucose or the like saccharide in which the hydrogen atom of the OH group is partly or wholly substituted with an acyl group, as in WO2007/125764, paragraphs [0042] to [0065].

The amount of the plasticizer to be added is preferably from 0.1 to 25% by mass of the amount of the main ingredient, polymer, more preferably from 1 to 20% by mass, even more preferably from 3 to 15% by mass.

In case where the optically anisotropic layer A contains a plasticizer, preferably, the optically anisotropic layer B also contains the same plasticizer in the same ratio relative to at least one polymer of the main ingredient of the layer B.

Examples of plasticizer usable here include non-phosphate compounds. As the non-phosphate compound, widely usable here are high-molecular additives and low-molecular additives known as additives for cellulose acylate film. The amount of the additive to be in the retardation film (e.g., cellulose acylate film) is preferably from 1 to 35% by mass of the film, more preferably from 4 to 30% by mass, even more preferably from 10 to 25% by mass.

The non-phosphate compound may be a high-molecular additive having a recurring unit in the compound, and is preferably one having a number-average molecular weight of from 700 to 10000. The high-molecular additive has the function of accelerating the evaporation speed of solvent and reducing the residual solvent amount. Further, from the viewpoint of film modification for enhancing the mechanical properties, imparting flexibility, imparting water absorption resistance and reducing the moisture permeability, the additive exhibits useful effects.

The number-average molecular weight of the non-phosphate ester-type high-molecular additive is more preferably from 700 to 8000, even more preferably from 700 to 5000, still more preferably from 1000 to 5000.

Next, the high-molecular-weight additives, non-phosphate compounds, which can be used in the invention, will be described in detail. However, the non-phosphate compounds which can be used in the invention are not limited to the following examples.

Examples of the high-molecular-weight-additive, which is a non-phosphate compound, include polyester-type polymers such as aliphatic polyester-type polymers and aromatic polyester-type polymers, and any copolymers of polyester component(s) and other component(s); and preferable examples thereof include aliphatic polyester-type polymers, aromatic polyester-type polymers, copolymers of polyester-type polymers (e.g. aliphatic polyester-type polymers and aromatic polyester-type polymers) and acryl-type polymers, and copolymers of polyester-type polymers (e.g. aliphatic polyester-type polymers and aromatic polyester-type polymers) and styrene-type polymers.

The polyester-type polymers, which can be used in the invention, may be produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms, and both ends of the reaction product may be as such, or may be blocked by further reaction with a monocarboxylic acid, a monoalcohol or a phenol. The terminal blocking may be effected for the reason that the absence of a free carboxylic acid in the polymer is effective for the storability thereof. The dicarboxylic acid for the polyester-type polymer is preferably a C₄₋₂₀ aliphatic dicarboxylic residue or a C₈₋₂₀ aromatic dicarboxylic residue.

The aliphatic dicarboxylic acids having from 2 to 20 carbon atoms preferably for use in the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred dicarboxylic acids are succinic acid, glutaric acid and adipic acid.

The diol used for the high-molecular-weight additive may be selected from aliphatic diols having from 2 to 20 carbon atoms and alkyl ether diols having from 4 to 20 carbon atoms.

Examples of the aliphatic diol having from 2 to 20 carbon atoms include alkyldiols and aliphatic diols, and more specifically include ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as any mixture thereof.

Preferable examples of the aliphatic diol include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, and 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, and 1,4-cyclohexanedimethanol.

Preferable examples of the alkyl ether diol having from 4 to 20 carbon atoms include polytetramethylene ether glycol, polyethylene ether glycol and polypropylene ether glycol, and any combinations thereof. The average degree of polymerization is preferably, but not limited, from 2 to 20, more preferably 2 to 10, further preferably from 2 to 5, especially preferably from 2 to 4. Examples of the commercially-available typical polyether glycol include Carbowax resin, Pluronics resin and Niax resin.

Especially preferred is a high-molecular-weight additive of which the terminal is blocked with an alkyl group or an aromatic group. The terminal protection with a hydrophobic functional group is effective against aging at high temperature and high humidity, by which the hydrolysis of the ester group is delayed.

Preferably, the polyester additive is protected with a monoalcohol residue or a monocarboxylic acid residue in order that both ends of the polyester additive are not a carboxylic acid or a hydroxyl group.

In this case, the monoalcohol residue is preferably selected from substituted or unsubstituted monoalcohol residues having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Examples of the alcohol residue, which is preferably used for terminal blocking, include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids include acetic acid, propionic acid, butanoic acid, caprylic acid, caproic acid, decanoic acid, dodecanoic acid, stearic acid, and oleic acid. Preferred aromatic monocarboxylic acids include benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, and acetoxybenzoic acid. One or more of these may be used either singly or as combination thereof.

The high-molecular-weight additive may be easily produced according to any of a thermal melt condensation method of polyesterification or interesterification of the dicarboxylic acid and diol and/or monocarboxylic acid or monoalcohol for terminal blocking, or according to an interfacial condensation method of an acid chloride of those acids and a glycol in an ordinary manner. The polyester additives are described in detail in “Additives, Their Theory and Application” (by Miyuki Publishing, first original edition published on Mar. 1, 1973, edited by Koichi Murai). The materials described in JP-A 05-155809, 05-155810, 05-197073, 2006-259494, 07-330670, 2006-342227, 2007-003679 are also usable in the invention.

The aromatic polyester-type polymers may be prepared by carrying out copolymerization of polyester polymer(s) and any monomer(s) having an aromatic group. The monomer having an aromatic group may be one or more selected from C₈₋₂₀ aromatic dicarboxylic acids and C₆₋₂₀ aromatic diols. Examples of the C₈₋₂₀ aromatic dicarboxylic acids include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid. Among these, preferable examples are phthalic acid, terephthalic acid and isophthalic acid.

Examples of the C₆₋₂₀ aromatic diol include, but are not limited, bisphenol A, 1,2-hydroxy benzene, 1,3-hydroxy benzene, 1,4-hydroxy benzene and 1,4-benzene dimethanol; and preferable are bisphenol A, 1,4-hydroxy benzene and 1,4-benzene dimethanol.

The aromatic polyester-type polymer may be any combinations of the above-described polyester(s) and at least one aromatic dicarboxylic acid or at least one aromatic diol, and any combinations containing two or more types of ingredients are usable. As described above, the high-molecular-weight additives of which ends are blocked with an alkyl group or aromatic group are especially preferable. The method for blocking the ends may be carried out according to the above-described method.

The retardation film of the invention may contain other additive(s) such as any anti-degradation agents (e.g., antioxidant, peroxide-decomposition agent, radical inhibitor, metal deactivator, acid-trapping agent, and amine). Anti-degradation agents are described in detail in JP-A-3-199201, 5-1907073, 5-194789, 5-271471 and 6-107854. The amount of the anti-degradation agent is preferably from 0.01 to 1% by mass, and more preferably from 0.01 to 2% by mass with respect to the mass of the solution (dope). When the amount is less than 0.01% by mass, little effect of the added anti-degradation agent may be obtained. When the amount is larger than 1% by mass, the added anti-degradation agent may be come out through the film-surface (bleeding-out phenomenon). Specifically-preferable examples of the anti-degradation agent include butylated-hydroxy toluene (BHT) and tribenzyl amine (TBA).

In the embodiment wherein the optically anisotropic layer A contains any additive in an amount, preferably, as well as the layer A, the optically anisotropic layer contains the same additive in the same amount with respect to the amount of the main ingredient, at least one polymer.

The method of producing the retardation film of the invention is described below.

Preferably, the retardation film of the invention is produced according to a co-casting method. The co-casting method is favorable as stably producing the retardation film of the invention. One example of the co-casting method for producing the retardation film of the invention is described below.

The production method comprises:

preparing a liquid A that contains at least one polymer as the main ingredient and at least one refractivity-anisotropic material, and a liquid B1 that contains at least one polymer as the main ingredient but does not contain the above-mentioned at least one refractivity-anisotropic material, or a liquid B2 that contains at least one polymer as the main ingredient and contains the above-mentioned at least one refractivity-anisotropic material in a ratio smaller than that in the liquid A,

co-casting the liquid A and the liquid B1 or B2 onto the surface of a support to form a film thereon, and

stretching the film.

Depending on the coating method, the liquid A and the liquid B1 or B2 may be applied sequentially onto the support to form thereon a laminate of a refractivity-anisotropic layer A and a refractivity-anisotropic layer B, and thereafter if desired, the laminate may be stretched to produce the retardation film. In the coating method, however, the surface roughness of the support may be reflected on the surface of the coating film; and if so, even though the liquid A and the liquid B1 or B2 contains the same polymer as the main ingredient, there may be formed an interface on which the surface roughness of the support is reflected inside the produced retardation film and the optical properties of the retardation film may be thereby worsened as a whole.

One type of solution may be cast to produce a film, and in the process, the drying condition and the casting condition may be controlled to thereby gradually change the concentration of the refractivity-anisotropic material in the thickness direction of the formed film, in which, however, the concentration gradient continuously changes and therefore the effect of the invention that the film could exhibit a high optical compensation capability even though Re thereof is small is lowered.

The co-casting method of using the liquid A and the liquid B1 or B2 that differ from each other in the composition is free from the problems with these methods, and can therefore stably produce the retardation film having good properties of the invention.

An example of the co-casting method for producing the retardation film of the invention is concretely described below.

First, the liquid A that contains at least one polymer as the main ingredient and at least one refractivity-anisotropic material, and the liquid B1 that contains at least one polymer as the main ingredient but does not contain the above-mentioned at least one refractivity-anisotropic material, or the liquid B2 that contains at least one polymer as the main ingredient and contains the above-mentioned at least one refractivity-anisotropic material in a ratio smaller than that in the liquid A are prepared. The solvent for use in preparing these dopes (in this description, “dope” means a solution or dispersion prepared by dissolving or dispersing the main ingredient polymer and other constitutive ingredients in a solvent, and “dope” as referred to hereinunder includes any of the liquid A, the liquid B1 and the liquid B2) is not specifically defined. Examples of the solvent which can be used for preparing the dope include aromatic hydrocarbons such as benzene and toluene; halogenated hydrocarbons such as dichloromethane and chlorobenzene; alcohols such as methanol, ethanol, n-propanol, n-butanol and diethylene glycol; ketones such as acetone and methyl ethyl ketone; esters such as methyl acetate, ethyl acetate and propyl acetate; and ethers such as tetrahydrofuran and methyl cellosolve.

For preparing a dope containing any cellulose acylate as a main ingredient, C₁₋₇ halogenated hydrocarbons are preferably used, and dichloromethane is especially preferable. Preferably, one or more types of C₁₋₅ alcohols are used along with dichloromethane, in terms of solubility of the cellulose acylate, peeling-off properties of the cast-film from a support, mechanical strength of the film and optical properties of the film. The amount of the alcohol is preferably from 2% by mass to 25%, and more preferably from 5% by mass to 20% by mass with respect to the total mass of the solvent. Examples of the alcohol include methanol, ethanol, n-propanol, isopropanol and n-butanol. And methanol, ethanol, n-butanol or any mixtures thereof are preferable.

For reducing the influence on the environment as much as possible, the solvent-formulation without dichloromethane has been proposed. For this purpose, C₄₋₁₂ ethers, C₃₋₁₂ ketones, and C₃₋₁₂ esters are preferable, and, especially, methyl acetate is preferable. And any mixture thereof may be used. Such ethers, ketones and esters may have any cyclic structure. Any compounds having at least two selected from ether, ketone and ester functional groups (that is, —O—, —CO— and —COO—) may be used as a solvent. The solvent may be selected from the compounds having other functional group such as alcoholic hydroxide. The number of carbon atoms in the solvent, having at least two types of functional groups, preferably falls within any one of the above-described preferable ranges.

Not specifically defined, the concentration of the refractivity-anisotropic material in the liquid A may be determined in accordance with the type of the material, the type of the polymer to be used along with it, and the use of the film. In general, preferably, the concentration of the material is from 0.1 to 30% by mass of all the mass of the solid fraction except the solvent in the liquid A, more preferably from 0.5 to 20% by mass, even more preferably from 1 to 10% by mass. However, the concentration should not be limited to the range.

The concentration of the refractivity-anisotropic material in the liquid B1 is 0 (zero).

The concentration of the refractivity-anisotropic material in the liquid B2 is not specifically defined so far as it is lower than the concentration of the refractivity-anisotropic material in the liquid A to be combined with the liquid B2.

One example of the guide of determining the composition of the liquid A and that of the liquid B1 or B2 is described below.

Preferably, the composition of the liquid A and that of the liquid B1 or B2 are determined as follows: The liquid A and the liquid B1, or the liquid A and the liquid B2 are each individually cast under the same condition as that in producing the retardation film of the invention, and then stretched also individually under the same condition as that in producing the retardation film of the invention; and the Nz factor of the thus-prepared two films could differ from each other by at least 2.0 (more preferably at least 5.0, even more preferably at least 10.0). Co-casting the liquid A and the liquid B1 or B2, of which the composition satisfies the condition, could produce a retardation film in which the Nz factor of the optically anisotropic layers A and B differs from each other by at least 2.0.

In an embodiment of the method for producing the retardation film for use for optical compensation in a VA-mode liquid-crystal display device, one example of the guide for determining the composition of the liquid A, that of the liquid 81 and that of the liquid B2 is as follows:

Preferably, the composition of the liquid A and that of the liquid B1 or B2 are determined as follows: The liquid A and the liquid B1, or the liquid A and the liquid B2 are each individually cast under the same condition as that in producing the retardation film of the invention, and then stretched also individually under the same condition as that in producing the retardation film of the invention; and of the thus-produced two films, the film formed of the liquid A could exhibit a biaxial plate-like property and the film formed of the liquid B1 or B2 could exhibit a C plate-like property. In this description, the C plate-like property means that the film has Re of from −5 to 5 nm and Rth of from 30 to 120 nm.

Next, the thus-prepared dopes are co-cast. The co-casting in the invention is not specifically defined. For example, a conventional known co-casting method of using a feed block-type casting die as in JP-A 2008-132778 is employable here. The feed block-type casting die is a casting device having a joining unit of joining two or more dopes on the upstream side of the casting die.

The liquid A and the liquid B1, or the liquid A and the liquid B2 are cast onto a support through such a feed block-type casting die and dried thereon to produce the intended retardation film of the invention. In the embodiment where the liquid A and the liquid B1, or the liquid A and the liquid B2 are co-cast through a two-layer co-casting die, when the liquid A having a higher concentration of the refractivity-anisotropic material is cast on the support side, then the refractivity-anisotropic material would diffuse and the intermittent change in the concentration of the refractivity-anisotropic layer in the thickness direction of the film would be lost. As a result, the effect of exhibiting a high optical compensation capability of the invention even though Re of the film is small would be lowered. When the two liquids are co-cast with the liquid B1 or B2 kept on the support side, then the refractivity-anisotropic material could be prevented from being diffusing during the drying step on the support, and the intermittent change in the concentration of the refractivity-anisotropic material in the thickness direction of the film could be stably realized. As a result, a good retardation film exhibiting a high optical compensation capability even though Re thereof is small can be produced.

In case where the dope viscosity is high or where casting is attained at a high speed, the dope liquid film to be cast through the co-casting die would be unstable and would therefore have a sharkskin-like surface, and the thus-produced film of the type would be unfavorable for use thereof as a retardation film. The sharkskin phenomenon could be retarded by lowering the viscosity of the dope liquid film to be in contact with air or the viscosity of the dope to be in contact with the support.

Concretely, along with the liquid A and the liquid B1 or B2, or in place of these, a liquid a having the same composition as that of the liquid A but having a lower concentration than that of the liquid A, and/or a liquid b1 or b2 having the same composition as that of the liquid B1 or B2 but having a lower concentration than that of the liquid B1 or B2 are prepared.

In an embodiment of using a three-layered structure co-casting die, the liquids are co-cast in the following order from the support surface side:

the liquid b1, the liquid B1 and the liquid a;

the liquid b1, the liquid A and the liquid a; or

the liquid b2, the liquid A and the liquid a,

thereby giving a retardation film of the invention having a good surface condition.

In an embodiment of using a four-layered structure co-casting die, the liquids are co-cast in the following order from the support surface side:

the liquid b1, the liquid B1, the liquid A and the liquid a; or

the liquid b2, the liquid B2, the liquid A and the liquid a, thereby giving a retardation film of the invention having a good surface condition.

In a case where plural cellulose acylate solutions are cast, the dopes may be individually cast through plural casting mouths arranged at intervals in the running direction of the metal support, and laminated to give a film (in a so-called sequential casting method); and for example, the methods described in JP-A 61-158414, 1-122419 and 11-198285 could be applicable thereto. For example, the dope of the liquid B1 or B2 is cast through the first die on the upstream side of in the running direction, and the dope of the liquid A is cast through the second die on the downstream side to give the film of the invention.

Also in this case, when the dope viscosity is high or the casting is attained at a high speed, then the dope liquid film cast through the co-casting die would be unstable; and therefore, for the first die and the second die, a three-layer co-casting die may be used to lower the viscosity of both surfaces of the individual dope liquid films, and a film having a good surface condition may be thereby produced.

In the invention, dopes of any other functional films (for example, for adhesive layer, dye layer, antistatic layer, antihalation layer, UV absorbing layer, polarization layer, etc.) may be cast simultaneously along with the dope of the liquid A and the dope of the liquid B1 or B2, not detracting from the effect of the invention. For example, dopes differing from each other in the concentration of the plasticizer, the UV absorbent, the mat agent and the like therein may be co-cast to product a laminate-structured film. For example, a film having a constitution of skin layer/core layer/skin layer may be produced. For example, the mat agent may be incorporated in a larger amount in the skin layer, or may be incorporated only in the skin layer. The plasticizer and the UV absorbent may be incorporated in a larger amount in the core layer than in the skin layer, or may be incorporated only in the core layer. The type of the plasticizer and that of the UV absorbent to be incorporated may be made to differ between the core layer and the skin layer; and for example, a low-volatile plasticizer and/or UV absorbent may be incorporated in the skin layer, and a high-performance plasticizer or a high-performance UV absorbent may be added to the core layer.

An embodiment of the layer constitution where Re and Rth of the two skin layers are the same is unfavorable even though there is a difference between the Nz factor of the core layer and that of the skin layer, since no circular retardation occurs, or that is, the circular retardation is 0. On the other hand, an embodiment where Re and Rth of the two skin layers differ is favorable, as capable of providing a circular retardation, since the amount of rotation (Re/Rth) differs though the Nz factor is the same. In other words, a case in which the Nz factor of the core layer differs from that of the skin layer and which provides a circular retardation is a favorable embodiment of the invention.

The dopes co-cast on a support form a web on the support, and then this is optionally heated to remove the solvent, and thereafter this is peeled away from the support.

Regarding the co-casting, the contents of JP-A 2008-132778 may be referred to herein.

The film peeled away from the support is thereafter stretched. The stretching treatment may be monoaxial stretching or biaxial stretching. For the stretching, a tenter may be used. The film may be stretched in the machine direction between rolls. Preferably, the film is stretched in the transverse direction (TD) perpendicular to the casting direction. The draw ratio in stretching is preferably from 1 to 300%, more preferably from 1 to 100%, even more preferably from 1 to 70%, still more preferably from 10 to 50%.

Regarding the method and the condition for the stretching treatment, Examples described in JP-A 62-115035, 4-152125, 4-284211, 4-298310 and 11-48271 may be referred to.

The thickness of the retardation film of the invention is not specifically defined. In case where the film is produced according to a two-layer or more multilayer co-casting method, in general, the film thickness could be from 30 to 200 μm or so.

In the embodiment where the liquid A and the liquid B1 or B2 are cast through a two-layer casting die to produce a retardation film, the thickness of the layer of the liquid A may be the same as or different from the thickness of the layer of the liquid B1 or B2.

In the embodiment of three-layer or four-layer constitution, the thickness of the constitutive layers is not specifically defined. Preferably, the outer layer of a low-viscosity dope is thinner than the inner core layer of a high-viscosity dope.

### 2. Polarizing Plate:

The invention also provides a polarizing plate comprising at least the retardation film of the invention and a linear polarizing film (in this description, this may be simply referred to as “polarizing film”). The retardation film of the invention may serve as a protective film for the linear polarizing film. The surface and the back of the retardation film of the invention differ in the Nz factor thereof. Preferably, the retardation film is stuck to the polarizing film in such a manner that the side of the retardation film having a larger Nz factor could face the polarizing film.

The linear polarizing film may be selected from coating-type polarizing films as typified by Optiva Inc., iodine-based polarizing films and dichroic-dye based polarizing films. Iodine or dichroic dye molecules are oriented in binder so as to have a polarizing capability. Iodine or dichroic dye molecules may be oriented along with binder molecules, or iodine molecules may aggregate themselves in the same manner of liquid crystal and be aligned in a direction. Generally, commercially available polarizing films are produced by soaking a stretched polymer film in a solution of iodine or dichroic dye and impregnating the polymer film with molecules of iodine or dichroic dye.

On the surface of the polarizing film which is opposite to the surface having the retardation film of the invention thereon, preferably, a polymer film is disposed as a protective film, that is, a constitution of the retardation film/polarizing film/polymer film is preferable. Examples of the polymer film, which can be used as the protective film, include, but are not limited, any films containing, as a main ingredient, cellulose acytales (e.g. cellulose acetate, cellulose propionate, and cellulose butyrate), polyolefins (e.g. norbornene-type polymer and polypropylene), poly(meth)acrylates (e.g. polymethylmethacrylate), polycarbonates, polyesters and polysulfones. Commercially-available polymer films may be used, and as an example of cellulose acylate films, “TD80UL” (produced by FUJIFILM), and as an example of norbornene-type polymer films, “ARTON” (produced by JSR) or “ZEONOR” (produced by ZEON) are exemplified.

On the protective film, preferably, an antireflection film, which may have antifouling and abrasion-resistant properties, is disposed. Any antireflection film may be used.

### 3. Liquid Crystal Display Device

The present invention relates to also liquid crystal display devices having the retardation film of the invention.

One example of the liquid crystal display device comprises at least one polarizing plate of the present invention. The retardation film may contribute to improving the displaying qualities of a liquid crystal display device employing any mode by its novel optical compensation properties. More specifically, the retardation film of the present invention may contribute to improving the displaying qualities of a liquid crystal display device employing any mode such as a TN (Twisted Nematic), IPS (In-Plane Switching), OCB (Optically Compensatory Bend), VA (Vertically Aligned) and ECB (Electrically Controlled Birefringence) by its novel optical compensation properties. Especially, the retardation film of the present invention is preferably used for optical compensation of a liquid crystal display device employing a VA or IPS-mode, and more preferably a VA-mode.

### EXAMPLES

Paragraphs below will further specifically explain the present invention referring to Examples and Comparative Examples, without limiting the present invention. The lubricant compositions in Examples and Comparative Examples were evaluated according to the methods described below.

### 1. Example 1

### 1.-1 Preparation of Solution A-1

The ingredients mentioned below were mixed in the ratio shown below to prepare a cellulose acylate solution A-1.

| | |
|---|---|
| Cellulose acylate having a degree | 100 parts by mass |
| of substitution with acetyl group of 2.81 | |
| Compound F-1 | 4 parts by mass |
| Triphenyl phosphate | 3 parts by mass |
| Diphenyl phosphate | 2 parts by mass |
| Methylene chloride | 418 parts by mass |
| Methanol | 62 parts by mass |

Compound F-1:

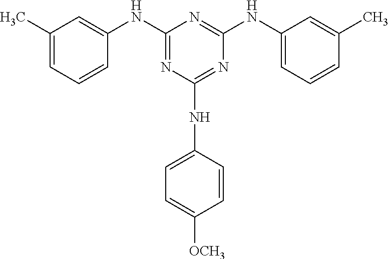

### 1.-2 Preparation of Solution B

The ingredients mentioned below were mixed in the ratio shown below to prepare a cellulose acylate solution B:

| | | |
|---|---|---|
| Cellulose acylate having a degree of | 100 | parts by mass |
| substitution with acetyl group of 2.85 | | |
| Compound F-1 | 1 | part by mass |
| Triphenyl phosphate | 7 | parts by mass |
| Diphenyl phosphate | 4 | parts by mass |
| Methylene chloride | 418 | parts by mass |
| Methanol | 62 | parts by mass |

### 1.-3 Production of Film 101

Using a band caster, the cellulose acylate solution A-1 and the cellulose acylate solution B were co-cast to be 90 μm thick and 50 μm thick, respectively; and the resulting web was peeled away from the band and then dried at 130° C. for 30 minutes. Subsequently, this was stretched in TD by 20% under the condition of 180° C. to give a cellulose acylate film having a thickness of 120 μm. This was used as film 101.

### 2. Example 2

### 2.-1 Preparation of Solution A-2

The ingredients mentioned below were mixed in the ratio shown below to prepare a cellulose acylate solution A-2.

| | |
|---|---|
| Cellulose acylate having a degree of | 100 parts by mass |
| substitution with acetyl group of 2.81 | |
| Compound F-1 | 7 parts by mass |
| Triphenyl phosphate | 3 parts by mass |
| Diphenyl phosphate | 2 parts by mass |
| Methylene chloride | 418 parts by mass |
| Methanol | 62 parts by mass |

### 2.-2 Production of Film 102

Using a band caster, the cellulose acylate solution A-2 and the cellulose acylate solution B were co-cast to be 90 μm thick and 50 μm thick, respectively; and the resulting web was peeled away from the band and then dried at 130° C. for 30 minutes. Subsequently, this was stretched in TD by 18% under the condition of 180° C. to give a cellulose acylate film having a thickness of 120 μm. This was used as film 102.

### 3. Example 3

### 3.-1 Preparation of Solution A-3

The ingredients mentioned below were mixed in the ratio shown below to prepare a cellulose acylate solution A-3.

| | |
|---|---|
| Cellulose acylate having a degree of | 100 parts by mass |
| substitution with acetyl group of 2.81 | |
| Compound F-1 | 7 parts by mass |
| Triphenyl phosphate | 3 parts by mass |
| Diphenyl phosphate | 2 parts by mass |
| Methylene chloride | 418 parts by mass |
| Methanol | 62 parts by mass |

### 3.-2 Production of Film 103

Using a band caster, the cellulose acylate solution A-3 and the cellulose acylate solution B were co-cast to be 90 μm thick and 50 μm thick, respectively; and the resulting web was peeled away from the band and then dried at 130° C. for 30 minutes. Subsequently, this was stretched in TD by 30% under the condition of 180° C. to give a cellulose acylate film having a thickness of 110 μm. This was used as film 103.

### 4. Example 4

### 4.-1 Preparation of Solution A-4

The ingredients mentioned below were mixed in the ratio shown below to prepare a cellulose acylate solution A-4.

| | |
|---|---|
| Cellulose acylate having a degree of | 100 parts by mass |
| substitution with acetyl group of 2.81 | |
| Compound F-1 | 4 parts by mass |
| Triphenyl phosphate | 3 parts by mass |
| Diphenyl phosphate | 2 parts by mass |
| Methylene chloride | 418 parts by mass |
| Methanol | 62 parts by mass |

### 4.-2 Production of Film 104

Using a band caster, the cellulose acylate solution A-4 and the cellulose acylate solution B were co-cast to be 70 μm thick and 90 μm thick, respectively; and the resulting web was peeled away from the band and then dried at 130° C. for 30 minutes. Subsequently, this was stretched in TD by 26% under the condition of 180° C. to give a cellulose acylate film having a thickness of 130 μm. This was used as film 104.

### 5. Example 5

### 5.-1 Preparation of Solution A-5

The ingredients mentioned below were mixed in the ratio shown below to prepare a cellulose acylate solution A-5.

| | |
|---|---|
| Cellulose acylate having a degree of | 100 parts by mass |
| substitution with acetyl group of 2.81 | |
| Compound F-1 | 4 parts by mass |
| Triphenyl phosphate | 3 parts by mass |
| Diphenyl phosphate | 2 parts by mass |
| Methylene chloride | 418 parts by mass |
| Methanol | 62 parts by mass |

### 5.-2 Production of Film 105

Using a band caster, the cellulose acylate solution A-5 and the cellulose acylate solution B were co-cast to be 90 μm thick and 80 μm thick, respectively; and the resulting web was peeled away from the band and then dried at 130° C. for 30 minutes. Subsequently, this was stretched in TD by 16% under the condition of 180° C. to give a cellulose acylate film having a thickness of 150 μm. This was used as film 105.

### 6. Example 6

### 6.-1 Preparation of Solution A-6

The ingredients mentioned below were mixed in the ratio shown below to prepare a cellulose acylate solution A-6.

| | |
|---|---|
| Cellulose acylate having a degree of | 100 parts by mass |
| substitution with acetyl group of 2.81 | |
| Compound F-1 | 4 parts by mass |
| Triphenyl phosphate | 3 parts by mass |
| Diphenyl phosphate | 2 parts by mass |
| Methylene chloride | 418 parts by mass |
| Methanol | 62 parts by mass |

### 6.-2 Production of Film 106

Using a band caster, the cellulose acylate solution A-6 and the cellulose acylate solution B were co-cast to be 70 μm thick and 80 μm thick, respectively; and the resulting web was peeled away from the band and then dried at 130° C. for 30 minutes. Subsequently, this was stretched in TD by 36% under the condition of 180° C. to give a cellulose acylate film having a thickness of 120 μm. This was used as film 106.

### 7. Example 7

### 7.-1 Preparation of Solution A-7

The ingredients mentioned below were mixed in the ratio shown below to prepare a cellulose acylate solution A-7.

| | |
|---|---|
| Cellulose acylate having a degree of | 100 parts by mass |
| substitution with acetyl group of 2.81 | |
| Compound F-1 | 6 parts by mass |
| Triphenyl phosphate | 3 parts by mass |
| Diphenyl phosphate | 2 parts by mass |
| Methylene chloride | 418 parts by mass |
| Methanol | 62 parts by mass |

### 7.-2 Production of Film 107

Using a band caster, the cellulose acylate solution A-7 and the cellulose acylate solution B were co-cast to be 70 μm thick and 80 μm thick, respectively; and the resulting web was peeled away from the band and then dried at 130° C. for 30 minutes. Subsequently, this was stretched in TD by 35% under the condition of 180° C. to give a cellulose acylate film having a thickness of 120 μm. This was used as film 107.

### 8. Comparative Example 1

### 8.-1 Preparation of Solution H-1

The ingredients mentioned below were mixed in the ratio shown below to prepare a cellulose acylate solution H-1.

| | |
|---|---|
| Cellulose acylate having a degree of | 100 parts by mass |
| substitution with acetyl group of 2.81 | |
| Compound F-1 | 7 parts by mass |
| Triphenyl phosphate | 3 parts by mass |
| Diphenyl phosphate | 2 parts by mass |
| Methylene chloride | 418 parts by mass |
| Methanol | 62 parts by mass |

### 8.-2 Production of Film H-1

Using a band caster, the cellulose acylate solution H-1 was cast, and the resulting web was peeled away from the band and then dried at 130° C. for 30 minutes. Subsequently, this was stretched in TD by 22% under the condition of 180° C. to give a cellulose acylate film having a thickness of 75 μm. This was used as film H-1.

### 9. Comparative Example 2

### 9.-1 Preparation of Solution H-2

The ingredients mentioned below were mixed in the ratio shown below to prepare a cellulose acylate solution H-2.

| | | |
|---|---|---|
| Cellulose acylate having a degree of substitution | 100 | parts by mass |
| with acetyl group of 2.81 | | |
| Compound F-1 | 7 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 9.-2 Production of Film H-2

Using a band caster, the cellulose acylate solution H-2 was cast, and the resulting web was peeled away from the band and then dried at 130° C. for 30 minutes. Subsequently, this was stretched in TD by 18% under the condition of 180° C. to give a cellulose acylate film having a thickness of 93 μm. This was used as film H-2.

### 10. Comparative Example 3

### 10.-1 Preparation of Solution H-3

The ingredients mentioned below were mixed in the ratio shown below to prepare a cellulose acylate solution H-3.

| | | |
|---|---|---|
| Cellulose acylate having a degree of substitution | 100 | parts by mass |
| with acetyl group of 2.81 | | |
| Compound F-1 | 7 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 10.-2 Production of Film H-3

Using a band caster, the cellulose acylate solution H-3 was cast, and the resulting web was peeled away from the band and then dried at 130° C. for 30 minutes. Subsequently, this was stretched in TD by 35% under the condition of 180° C. to give a cellulose acylate film having a thickness of 80 μm. This was used as film H-3.

### 11. Comparative Example 4

### 11.-1 Preparation of Solution H-4

The ingredients mentioned below were mixed in the ratio shown below to prepare a cellulose acylate solution H-4.

| | | |
|---|---|---|
| Cellulose acylate having a degree of substitution | 100 | parts by mass |
| with acetyl group of 2.81 | | |
| Compound F-1 | 7 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 11.-2 Production of Film H-4

Using a band caster, the cellulose acylate solution H-4 was cast, and the resulting web was peeled away from the band and then dried at 130° C. for 30 minutes. Subsequently, this was stretched in TD by 35% under the condition of 180° C. to give a cellulose acylate film having a thickness of 93 μm. This was used as film H-4.

### 12. Example 8

### 12.-1 Preparation of Solution A-8

The ingredients mentioned below were mixed in the ratio shown below to prepare a cellulose acylate solution A-8.

| | | |
|---|---|---|
| Cellulose acylate having a degree of substitution | 100 | parts by mass |
| with acetyl group of 2.81 | | |
| Compound F-1 | 4 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 12.-2 Production of Film 108

Using a band caster, the cellulose acylate solution A-8 and the cellulose acylate solution B were co-cast to be 105 μm thick and 50 μm thick, respectively; and the resulting web was peeled away from the band and then dried at 130° C. for 30 minutes. Subsequently, this was stretched in TD by 25% under the condition of 180° C. to give a cellulose acylate film having a thickness of 135 μm. This was used as film 108.

### 13. Example 9

### 13.-1 Preparation of Solution A-9

The ingredients mentioned below were mixed in the ratio shown below to prepare a cellulose acylate solution A-9.

| | | |
|---|---|---|
| Cellulose acylate having a degree of substitution with acetyl group of 2.81 | 100 | parts by mass |
| Compound F-1 | 2.5 | parts by mass |
| Compound F-2 shown below | 2 | parts by mass |
| Compound F-3 shown below | 2 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

Compound F-2: 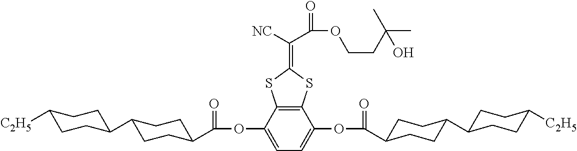
Compound F-3:

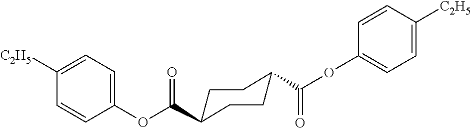

### 13.-2 Production of Film 109

Using a band caster, the cellulose acylate solution A-9 and the cellulose acylate solution B were co-cast to be 67 μm thick and 90 μm thick, respectively; and the resulting web was peeled away from the band and then dried at 130° C. for 30 minutes. Subsequently, this was stretched in TD by 35% under the condition of 180° C. to give a cellulose acylate film having a thickness of 130 μm. This was used as film 109.

### 14. Example 10

### 14.-1 Preparation of Solution A-10

The ingredients mentioned below were mixed in the ratio shown below to prepare a cellulose acylate solution A-10.

| | | |
|---|---|---|
| Cellulose acylate having a degree of substitution | 100 | parts by mass |
| with acetyl group of 2.81 | | |
| Compound F-1 | 2.5 | parts by mass |
| Compound F-2 | 2 | parts by mass |
| Compound F-3 | 2 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 14.-2 Preparation of Solution D

The ingredients mentioned below were mixed in the ratio shown below to prepare a cellulose acylate solution D.

| | |
|---|---|
| Cellulose acylate having a degree of | 100 parts by mass |
| substitution with acetyl group of 2.81 | |
| Compound F-4 shown below | 6 parts by mass |
| Triphenyl phosphate | 7 parts by mass |
| Diphenyl phosphate | 5 parts by mass |
| Methylene chloride | 418 parts by mass |
| Methanol | 62 parts by mass |

Compound F-4:

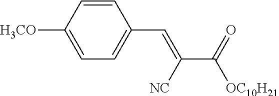

Using a band caster, the cellulose acylate solution A-10 and the cellulose acylate solution D were co-cast to be 60 μm thick and 75 μm thick, respectively; and the resulting web was peeled away from the band and then dried at 130° C. for 30 minutes. Subsequently, this was stretched in TD by 35% under the condition of 180° C. to give a cellulose acylate film having a thickness of 100 μm. This was used as film 110.

### 15. Example 11

### 15.-1 Preparation of Solution A-11

The ingredients mentioned below were mixed in the ratio shown below to prepare a cellulose acylate solution A-11.

| | | |
|---|---|---|
| Cellulose acylate having a degree of substitution | 100 | parts by mass |
| with acetyl group of 2.81 | | |
| Compound F-1 | 4 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 15.-2 Preparation of Solution B-2

The ingredients mentioned below were mixed in the ratio shown below to prepare a cellulose acylate solution B-2.

| | | |
|---|---|---|
| Cellulose acylate having a degree of substitution | 100 | parts by mass |
| with acetyl group of 2.85 | | |
| Compound F-1 | 2 | parts by mass |
| Triphenyl phosphate | 7 | parts by mass |
| Diphenyl phosphate | 4 | parts by mass |
| Methylene chloride | 418 | parts by mass |
| Methanol | 62 | parts by mass |

### 15.-3 Production of Film 111

Using a band caster, the cellulose acylate solution A-11 and the cellulose acylate solution B-2 were co-cast to be 100 μm thick and 50 μm thick, respectively; and the resulting web was peeled away from the band and then dried at 130° C. for 30 minutes. Subsequently, this was stretched in TD by 27% under the condition of 180° C. to give a cellulose acylate film having a thickness of 130 μm. This was used as film 111.

### 16. Example 12

Using a band caster, the cellulose acylate solution A-11 and the cellulose acylate solution B-2 were co-cast to be 100 μm thick and 50 μm thick, respectively; and the resulting web was peeled away from the band and then dried at 130° C. for 30 minutes. Subsequently, this was stretched in TD by 30% under the condition of 180° C. to give a cellulose acylate film having a thickness of 125 μm. This was used as film 112.

### 17. Comparative Example 5

### 17.-1 Preparation of Solution H-5

The ingredients mentioned below were mixed in the ratio shown below to prepare a cellulose acylate solution H-5.

| | | |
|---|---|---|
| Cellulose acylate having a degree of substitution | 100 | parts by mass |
| with acetyl group of 2.81 | | |
| Compound F-1 | 7 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 17.-2 Production of Film H-5

Using a band caster, the cellulose acylate solution H-5 was cast, and the resulting web was peeled away from the band and then dried at 130° C. for 30 minutes. Subsequently, this was stretched in TD by 27% under the condition of 180° C. to give a cellulose acylate film having a thickness of 83 μm. This was used as film H-5.

### 18. Comparative Example 6

The norbornene film built in a Toshiba's liquid-crystal panel, 32C7000 was peeled out, and an easy-adhesion layer was formed on the film surface. This was used as film H-6. Its thickness was 70 μm.

### 19. Optical Characteristics of Films

The optical characteristics of the produced films are summarized in the following Table.

TABLE 1

| | | Layer A | Layer B | | | | Wavelength | |
|---|---|---|---|---|---|---|---|---|
| | | *1 | *2 | | Circular | Re_off/ | Dispersion | |
| | Film | Re/Rth | Re/Rth | Difference | Retardation | Rth_off | ΔRe *3 | ΔRth *4 |
| | No. | [nm] | [nm] | in Nz Factor | [nm] | [nm] | [nm] | [nm] |
| Example 1 | 101 | 42/157 | 3/40 | 9.7 | 2.9 | 50/190 | 5 | 10 |
| Example 2 | 102 | 41/195 | 2/40 | 15.2 | 3.1 | 50/230 | 6 | 11 |
| Example 3 | 103 | 67/190 | 5/45 | 6.2 | 5.1 | 80/230 | 5 | 10 |
| Example 4 | 104 | 38/120 | 4/80 | 16.8 | 6.3 | 50/190 | 4 | 8 |
| Example 5 | 105 | 39/155 | 3/82 | 23.4 | 6.8 | 50/230 | 4 | 8 |
| Example 6 | 106 | 58/120 | 4/83 | 18.7 | 10.7 | 80/190 | 3 | 7 |
| Example 7 | 107 | 63/160 | 5/81 | 13.7 | 10.7 | 80/230 | 5 | 9 |
| Comparative | H-1 | 50/190 | — | — | — | 50/190 | −2 | −3 |
| Example 1 | | | | | | | | |
| Comparative | H-2 | 50/230 | — | — | — | 50/230 | −2 | −3 |
| Example 2 | | | | | | | | |
| Comparative | H-3 | 80/190 | — | — | — | 80/190 | −2 | −3 |
| Example 3 | | | | | | | | |
| Comparative | H-4 | 80/230 | — | — | — | 80/230 | −2 | −3 |
| Example 4 | | | | | | | | |
| Example 8 | 108 | 55/178 | 1/40 | 36.8 | 4.9 | 65/210 | 6 | 10 |
| Example 9 | 109 | 50/135 | 3/80 | 25.0 | 8.9 | 65/210 | 10 | −1 |
| Example 10 | 110 | 47/120 | 7/95 | 11.0 | 9.0 | 65/210 | 13 | −7 |
| Example 11 | 111 | 53/177 | 5/40 | 4.7 | 3.0 | 65/210 | 4 | 8 |
| Example 12 | 112 | 53/175 | 7/40 | 2.4 | 2.2 | 65/210 | 3 | 7 |
| Comparative | H-5 | 65/210 | — | — | — | 65/210 | −2 | −3 |
| Example 5 | | | | | | | | |
| Comparative | H-6 | 62/208 | — | — | — | 62/208 | 0 | 0 |
| Example 6 | | | | | | | | |

*1 Optically anisotropic layer A
*2 Optically anisotropic layer B
*3 ΔRe_off
*4 ΔRth_off

### 20. Production and Evaluation of Liquid-Crystal Display Device

### 20.-1 Production of Polarizing Plate

The surfaces of the films 101 to 112 and the films H-1 to H-5 produced in the above were saponified with alkali. Concretely, the film was dipped in an aqueous 1.5 N sodium hydroxide solution at 55° C. for 2 minutes, then washed in a water-washing bath at room temperature, and neutralized with 0.1 N sulfuric acid at 30° C. Again this was washed in a water-washing bath at room temperature, and dried with hot air at 100° C.

Next, a roll of polyvinyl alcohol film having a thickness of 80 μm was unrolled and continuously stretched by 5 times in an aqueous iodine solution and dried to give a polarizing film having a thickness of 20 μm. The polarizing film was sandwiched between any of the above-mentioned, alkali-saponified polymer films and a film of Fujitac TD80UL (by FUJIFILM) that had been alkali-saponified in the same manner as above, in such a manner that the saponified surfaces of those films could face the polarizing film, and these were stuck together with an aqueous 3% polyvinyl alcohol (Kuraray's PVA-117H) serving as an adhesive, thereby constructing a polarizing plate in which the polymer film and the film TD80UL are the protective films for the polarizing film.

The film H-6 was not alkali-saponified, and this was stuck to the surface of the polarizing film in such a manner that the easy-adhesion layer formed on the film could face the surface of the polarizing film. The others are the same as above to produce a polarizing plate.

### 20.-2 Production of Liquid-Crystal Display Device

Using the polarizing plates produced in the above, liquid-crystal display deices of Examples 1 to 12 and Comparative Examples 1 to 6 were constructed.

Concretely, a VA-mode liquid-crystal cell (Δnd=310 nm) was used, and the polarizing plate produced in the above was stuck to it on the backlight side to produce a liquid-crystal display device. For use as the retardation film between the polarizing plate on the panel side and the liquid-crystal cell (protective film for the liquid-crystal cell-side polarizing plate), any of the films T-1 to T-3 having the optical characteristics shown below was selected in consideration of the backlight-side retardation film to be combined with it and Δnd of the cell. The combination is shown in the following Table. The films T-1 to T-3 are all commercially-available cellulose acylate films.

Film T-1: Re 1 nm, Rth 60 nm

Film T-2: Re 1 nm, Rth 2 nm

Film T-3: Re 1 nm, Rth 40 nm

### 20.-3 Evaluation of Liquid-Crystal Display Device

Transmittance at the Time of Black Level and White Level of Display:

The liquid-crystal display devices constructed in the above were tested for the transmittance in the front direction (in the normal direction) and in an oblique direction (in the direction at a polar axis of 45 degrees and at an azimuth angle of 60 degrees) at the time of black level and white level of display, thereby computing the contrast ratio in the front direction and the contrast ratio in the oblique direction. The results are shown in the following Table.

Color Shift at the Time of Black Level of Display:

The liquid-crystal display devices constructed in the above were tested for the color shift, Δu′v′ (=√(u′max−u′min)²+(v′max−v′min)²) at the time of black level of display. In this, u′max (v′max) means the maximum u′ (v′) in a range of from 0 to 360 degrees; and u′min (v′min) means the minimum u′ (v′) in a range of from 0 to 360 degrees. The results are shown in the following Table.

TABLE 2

| | | | Evaluations in the | | |
|---|---|---|---|---|---|
| | | | oblique direction at | | |
| | | | the time of black level | | |
| | Backlight-side | Displaying-side | of display | | |
| | Protective | Protective Film*2 | Front | | Oblique |
| | Film*1 No. | No. | CR | Δu′v′ | CR |
| Example 1 | 101 | T-1 | 5050 | 0.08 | 49 |
| Example 2 | 102 | T-2 | 5100 | 0.09 | 51 |
| Example 3 | 103 | T-2 | 4700 | 0.07 | 75 |
| Example 4 | 104 | T-1 | 5300 | 0.09 | 50 |
| Example 5 | 105 | T-2 | 5250 | 0.09 | 51 |
| Example 6 | 106 | T-1 | 4900 | 0.09 | 74 |
| Example 7 | 107 | T-2 | 4800 | 0.08 | 74 |
| Comparative | H-1 | T-1 | 5000 | 0.12 | 49 |
| Example 1 | | | | | |
| Comparative | H-2 | T-2 | 4900 | 0.11 | 45 |
| Example 2 | | | | | |
| Comparative | H-3 | T-1 | 4600 | 0.16 | 73 |
| Example 3 | | | | | |
| Comparative | H-4 | T-2 | 4550 | 0.17 | 75 |
| Example 4 | | | | | |
| Example 8 | 108 | T-3 | 4950 | 0.08 | 85 |
| Example 9 | 109 | T-3 | 5000 | 0.05 | 87 |
| Example 10 | 110 | T-3 | 5050 | 0.03 | 86 |
| Example 11 | 111 | T-3 | 4900 | 0.08 | 85 |
| Example 12 | 112 | T-3 | 4850 | 0.08 | 86 |
| Comparative | H-5 | T-3 | 4700 | 0.12 | 84 |
| Example 5 | | | | | |
| Comparative | H-6 | T-3 | 4750 | 0.1 | 85 |
| Example 6 | | | | | |

*1This means the protective film of the polarizing plate disposed at the
backlight side, which was disposed at the liquid-crystal-cell side of the liquid
crystal display device.
*2This means the protective film of the polarizing plate disposed at the
displaying side, which was disposed at the liquid-crystal-cell side of the
liquid crystal display device.

From the data in the above Table, it is understandable that examples of the liquid-crystal display devices of the invention, comprising the retardation film of the invention, showed the almost equal or higher contrast ratio in the oblique direction, smaller color shift in the black state and the higher contrast ratio, compared with the comparative liquid-crystal display devices.

### 21. Example 13

### 21.-1 Preparation of Solution A-13

The ingredients mentioned below were mixed in the ratio shown below to prepare a cellulose acylate solution A-13.

| | | |
|---|---|---|
| ellulose acylate having a degree of substitution | 100 | parts by mass |
| with acetyl group of 2.81 | | |
| Compound F-1 | 4 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 21.-2 Production of Film 113

Using a band caster, the cellulose acylate solution A-13 and the cellulose acylate solution B were co-cast to be 60 μm thick and 60 μm thick, respectively; and the resulting web was peeled away from the band and then dried at 130° C. for 30 minutes. Subsequently, this was stretched in TD by 35% under the condition of 180° C. to give a cellulose acylate film having a thickness of 80 μm. This was used as film 113.

### 22. Example 14

Using a band caster, the cellulose acylate solution A-13 and the cellulose acylate solution B were co-cast to be 70 μm thick and 60 μm thick, respectively; and the resulting web was peeled away from the band and then dried at 130° C. for 30 minutes. Subsequently, this was stretched in TD by 35% under the condition of 180° C. to give a cellulose acylate film having a thickness of 90 μm. This was used as film 114.

### 23. Example 15

Using a band caster, the cellulose acylate solution A-13 and the cellulose acylate solution B were co-cast to be 80 μm thick and 50 μm thick, respectively; and the resulting web was peeled away from the band and then dried at 130° C. for 30 minutes. Subsequently, this was stretched in TD by 35% under the condition of 180° C. to give a cellulose acylate film having a thickness of 90 μm. This was used as film 115.

### 24. Example 16

Using a band caster, the cellulose acylate solution A-13 and the cellulose acylate solution B were co-cast to be 60 μm thick and 80 μm thick, respectively; and the resulting web was peeled away from the band and then dried at 130° C. for 30 minutes. Subsequently, this was stretched in TD by 35% under the condition of 180° C. to give a cellulose acylate film having a thickness of 100 μm. This was used as film 116.

### 25. Comparative Example 7

### 25.-1 Preparation of Solution H-7

The ingredients mentioned below were mixed in the ratio shown below to prepare a cellulose acylate solution H-7.

| | | |
|---|---|---|
| Cellulose acylate having a degree of substitution | 100 | parts by mass |
| with acetyl group of 2.81 | | |
| Compound F-1 | 4 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 25.-2 Production of Film H-7

Using a band caster, the cellulose acylate solution H-7 was cast, and the resulting web was peeled away from the band and then dried at 130° C. for 30 minutes. Subsequently, this was stretched in TD by 32% under the condition of 180° C. to give a cellulose acylate film having a thickness of 55 μm. This was used as film H-7.

### 26. Comparative Example 8

### 26.-1 Preparation of Solution H-8

The ingredients mentioned below were mixed in the ratio shown below to prepare a cellulose acylate solution H-8.

| | | |
|---|---|---|
| Cellulose acylate having a degree of substitution | 100 | parts by mass |
| with acetyl group of 2.81 | | |
| Compound F-1 | 5 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 26.-2 Production of Film H-8

Using a band caster, the cellulose acylate solution H-8 was cast, and the resulting web was peeled away from the band and then dried at 130° C. for 30 minutes. Subsequently, this was stretched in TD by 30% under the condition of 180° C. to give a cellulose acylate film having a thickness of 60 μm. This was used as film H-8.

### 27. Comparative Example 9

### 27.-1 Preparation of Solution H-9

The ingredients mentioned below were mixed in the ratio shown below to prepare a cellulose acylate solution H-9.

| | | |
|---|---|---|
| Cellulose acylate having a degree of substitution | 100 | parts by mass |
| with acetyl group of 2.81 | | |
| Compound F-2 | 2 | parts by mass |
| Compound F-3 | 6 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 27.-2 Production of Film H-9

Using a band caster, the cellulose acylate solution H-9 was cast, and the resulting web was peeled away from the band and then dried at 130° C. for 30 minutes. Subsequently, this was stretched in TD by 20% under the condition of 180° C. to give a cellulose acylate film having a thickness of 60 μm. This was used as film H-9.

### 28. Example 17

Using a band caster, the cellulose acylate solution A-13 and the cellulose acylate solution B were co-cast to be 73 μm thick and 50 μm thick, respectively; and the resulting web was peeled away from the band and then dried at 130° C. for 30 minutes. Subsequently, this was stretched in TD by 35% under the condition of 180° C. to give a cellulose acylate film having a thickness of 83 μm. This was used as film 117.

### 29. Example 18

Using a band caster, the cellulose acylate solution A-10 and the cellulose acylate solution D were co-cast to be 65 μm thick and 40 μm thick, respectively; and the resulting web was peeled away from the band and then dried at 130° C. for 30 minutes. Subsequently, this was stretched in TD by 35% under the condition of 180° C. to give a cellulose acylate film having a thickness of 65 μm. This was used as film 118.

### 30. Example 19

Using a band caster, the cellulose acylate solution A-13 and the cellulose acylate solution B-2 were co-cast to be 75 μm thick and 50 μm thick, respectively; and the resulting web was peeled away from the band and then dried at 130° C. for 30 minutes. Subsequently, this was stretched in TD by 35% under the condition of 180° C. to give a cellulose acylate film having a thickness of 85 μm. This was used as film 119.

### 31. Example 20

Using a band caster, the cellulose acylate solution A-13 and the cellulose acylate solution B-2 were co-cast to be 70 μm thick and 50 μm thick, respectively; and the resulting web was peeled away from the band and then dried at 130° C. for 30 minutes. Subsequently, this was stretched in TD by 40% under the condition of 180° C. to give a cellulose acylate film having a thickness of 80 μm. This was used as film 120.

### 32. Example 21

### 32.-1 Preparation of Solution A-21

The ingredients mentioned below were mixed in the ratio shown below to prepare a cellulose acylate solution A-21.

| | | |
|---|---|---|
| Cellulose acylate having a degree of substitution | 100 | parts by mass |
| with acetyl group of 2.81 | | |
| Compound F-1 | 4.6 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 32.-2 Preparation of Solution B-21

| | | |
|---|---|---|
| Cellulose acylate having a degree of substitution | 100 | parts by mass |
| with acetyl group of 2.81 | | |
| Compound F-1 | 4.3 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 32.-3 Production of Film 121

Using a band caster, the cellulose acylate solution A-21 and the cellulose acylate solution B-21 were co-cast to be 50 μm thick and 50 μm thick, respectively; and the resulting web was peeled away from the band and then dried at 130° C. for 30 minutes. Subsequently, this was stretched in TD by 35% under the condition of 180° C. to give a cellulose acylate film having a thickness of 60 μm. This was used as film 121.

### 33. Comparative Example 10

Using a band caster, the cellulose acylate solution A-13 was cast, and the resulting web was peeled away from the band and then dried at 130° C. for 30 minutes. Subsequently, this was stretched in TD by 35% under the condition of 180° C. to give a cellulose acylate film having a thickness of 60 μm. This was used as film H-10.

### 34. Comparative Example 11

The norbornene film built in a Sharp's liquid-crystal panel, LC-37XJ was peeled out, and an easy-adhesion layer was formed on the film surface. This was used as film H-11. Its thickness was 70 μm.

### 35. Comparative Example 12

The cellulose film built in a Sony's liquid-crystal panel, KDL-40F5 was peeled out, and an easy-adhesion layer was formed on the film surface. This was used as film H-12. Its thickness was 42 μm.

### 36. Comparative Example 13

### 36.-1 Preparation of Solution H-13

The ingredients mentioned below were mixed in the ratio shown below to prepare a cellulose acylate solution H-13.

| | | |
|---|---|---|
| Cellulose acylate having a degree of substitution | 100 | parts by mass |
| with acetyl group of 2.81 | | |
| Compound F-1 | 4 | parts by mass |
| Triphenyl phosphate | 3 | parts by mass |
| Diphenyl phosphate | 2 | parts by mass |
| Methylene chloride | 418 | parts by mass |
| Methanol | 62 | parts by mass |

### 36.-2 Production of Film H-13

Using a band caster, the cellulose acylate solution H-13 was cast, and the resulting web was dried on the band with dry air applied thereto at a temperature of 130° C. and at a wind speed of 3 m/sec for 20 minutes. Subsequently, this was stretched in TD by 35% under the condition of 180° C. to give a cellulose acylate film having a thickness of 60 μm. This was used as film H-13.

### 37. Optical Characteristics of Films

The optical characteristics of the produced films are summarized in the following Table.

TABLE 3

| | | Layer A | Layer B | | | | Wavelength | |
|---|---|---|---|---|---|---|---|---|
| | | *1 | *2 | | Circular | Re_off/ | Dispersion | |
| | Film | Re/Rth | Re/Rth | Difference | Retardation | Rth_off | ΔRe *3 | ΔRth *4 |
| | No. | [nm] | [nm] | in Nz Factor | [nm] | [nm] | [nm] | [nm] |
| Example 13 | 113 | 32/80 | 3/40 | 10.8 | 2.5 | 45/110 | 5 | 10 |
| Example 14 | 114 | 38/95 | 2/40 | 17.5 | 3.2 | 45/130 | 6 | 11 |
| Example 15 | 115 | 55/108 | 3/30 | 7.9 | 3.2 | 65/130 | 4 | 8 |
| Example 16 | 116 | 35/80 | 3/60 | 77.7 | 4.5 | 45/130 | 3 | 7 |
| Comparative | H-7 | 45/110 | — | 0 | — | 45/110 | −2 | −3 |
| Example 7 | | | | | | | | |
| Comparative | H-8 | 45/130 | — | 0 | — | 45/130 | −2 | −3 |
| Example 8 | | | | | | | | |
| Comparative | H-9 | 65/130 | — | 0 | — | 65/130 | −2 | −3 |
| Example 9 | | | | | | | | |
| Example 17 | 117 | 46/98 | 1/30 | 27.9 | 3.1 | 55/120 | 6 | 10 |
| Example 18 | 118 | 47/98 | 1/30 | 27.9 | 3.2 | 55/120 | 13 | −7 |
| Example 19 | 119 | 42/99 | 4/30 | 5.3 | 2.1 | 55/120 | 4 | 8 |
| Example 20 | 120 | 42/99 | 6/30 | 2.8 | 1.6 | 55/120 | 2 | 7 |
| Example 21 | 121 | 28/63 | 25/60 | 0.2 | 0.2 | 55/120 | −2 | −3 |
| Comparative | H-10 | 55/120 | — | 0 | — | 55/120 | −2 | −3 |
| Example 10 | | | | | | | | |
| Comparative | H-11 | 55/120 | — | 0 | — | 55/120 | 0 | 0 |
| Example 11 | | | | | | | | |
| Comparative | H-12 | 55/120 | — | 0 | — | 55/120 | 2 | 3 |
| Example 12 | | | | | | | | |
| Comparative | H-13 | — | — | — | 0.3 | 55/120 | −2 | −3 |
| Example 13 | | | | | | | | |

*1 Optically anisotropic layer A
*2 Optically anisotropic layer B
*3 ΔRe_off
*4 ΔRth_off

### 38. Production and Evaluation of Liquid-Crystal Display Device

### 38.-1 Production of Polarizing Plate

The surfaces of the films 113 to 121, H-7 to H-10 and H-13 produced in the above were saponified with alkali. Concretely, the film was dipped in an aqueous 1.5 N sodium hydroxide solution at 55° C. for 2 minutes, then washed in a water-washing bath at room temperature, and neutralized with 0.1 N sulfuric acid at 30° C. Again this was washed in a water-washing bath at room temperature, and dried with hot air at 100° C.

Next, a roll of polyvinyl alcohol film having a thickness of 80 μm was unrolled and continuously stretched by 5 times in an aqueous iodine solution and dried to give a polarizing film having a thickness of 20 μm. The polarizing film was sandwiched between any of the above-mentioned, alkali-saponified polymer films and a film of Fujitac TD80UL (by FUJIFILM) that had been alkali-saponified in the same manner as above, in such a manner that the saponified surfaces of those films could face the polarizing film, and these were stuck together with an aqueous 3% polyvinyl alcohol (Kuraray's PVA-117H) serving as an adhesive, thereby constructing a polarizing plate in which the polymer film and the film TD80UL are the protective films for the polarizing film.

The films H-11 and H-12 were not alkali-saponified, and the film was stuck to the surface of the polarizing film in such a manner that the easy-adhesion layer formed on the film could face the surface of the polarizing film. The others are the same as above to produce a polarizing plate.

### 38.-2 Production of Liquid-Crystal Display Device

Using the polarizing plates produced in the above, liquid-crystal display deices of Examples 13 to 21 and Comparative Examples 7 to 13 were constructed.

Concretely, a VA-mode liquid-crystal cell (Δnd=300 nm) was used, and the polarizing plates were stuck to it on both the display panel side and the backlight side one by one as in the combination shown in the following Table, thereby constructing the intended liquid-crystal display devices. In the device, the slow axes of the retardation films were kept perpendicular to each other.

### 38.-3 Evaluation of Liquid-Crystal Display Device

Transmittance at the Time of Black Level and White Level of Display:

The liquid-crystal display devices constructed in the above were tested for the transmittance in the front direction (in the normal direction) and in an oblique direction (in the direction at a polar axis of 45 degrees and at an azimuth angle of 60 degrees) at the time of black level and white level of display, thereby computing the contrast ratio in the front direction and the contrast ratio in the oblique direction. The results are shown in the following Table.

Color shift at the time of black level of display:

The liquid-crystal display devices constructed in the above were tested for the color shift, Δu′v′ (=√(u′max−u′min)²+(v′max−v′min)²) at the time of black level of display. In this, u′max (v′max) means the maximum u′ (v′) in a range of from 0 to 360 degrees; and u′min (v′min) means the minimum u′ (v′) in a range of from 0 to 360 degrees. The results are shown in the following Table.

TABLE 4

| | | | Evaluations in the | | |
|---|---|---|---|---|---|
| | | | oblique direction at | | |
| | | | the time of black level | | |
| | Backlight-side | Displaying-side | of display | | |
| | Protective | Protective Film*2 | Front | | Oblique |
| | Film*1 No. | No. | CR | Δu′v′ | CR |
| Example 13 | 113 | 113 | 5400 | 0.05 | 52 |
| Example 14 | 114 | 114 | 5400 | 0.05 | 53 |
| Example 15 | 115 | 115 | 4950 | 0.04 | 52 |
| Example 16 | 116 | 116 | 5500 | 0.05 | 55 |
| Comparative | H-7 | H-7 | 5300 | 0.06 | 50 |
| Example 7 | | | | | |
| Comparative | H-8 | H-8 | 5300 | 0.07 | 53 |
| Example 8 | | | | | |
| Comparative | H-9 | H-9 | 4800 | 0.05 | 50 |
| Example 9 | | | | | |
| Example 17 | 117 | 117 | 5300 | 0.04 | 95 |
| Example 18 | 118 | 118 | 5350 | 0.02 | 97 |
| Example 19 | 119 | 119 | 5300 | 0.04 | 94 |
| Example 20 | 120 | 120 | 5250 | 0.05 | 95 |
| Example 21 | 121 | 121 | 5030 | 0.06 | 96 |
| Comparative | H-10 | H-10 | 5000 | 0.07 | 96 |
| Example 10 | | | | | |
| Comparative | H-11 | H-11 | 5100 | 0.06 | 98 |
| Example 11 | | | | | |
| Comparative | H-12 | H-12 | 5000 | 0.05 | 97 |
| Example 12 | | | | | |
| Comparative | H-13 | H-13 | 5050 | 0.07 | 96 |
| Example 13 | | | | | |

*1This means the protective film of the polarizing plate disposed at the
backlight side, which was disposed at the liquid-crystal-cell side of the liquid
crystal display device.
*2This means the protective film of the polarizing plate disposed at the
displaying side, which was disposed at the liquid-crystal-cell side of the
liquid crystal display device.

From the data in the above Table, it is understandable that examples of the liquid-crystal display devices of the invention, comprising the retardation film of the invention, showed the almost equal or higher contrast ratio in the oblique direction, smaller color shift in the black state and the higher contrast ratio, compared with the comparative liquid-crystal display devices.

In particular, in the liquid-crystal display devices of Examples 17 to 19, used was the retardation film of the invention of which Re-off, Rth-off, the difference in Nz factor and the circulation retardation are all within the preferred ranges; and therefore it is understandable that these liquid-crystal display devices were all extremely excellent in that the front CR thereof was high, the color shift thereof was small and the viewing angle CR thereof was high.

The film H-13 used in Comparative Example 13 could exhibit a circular retardation; however, as compared with the films in Examples, this could not produce so great improvement. The reason would be because, in the production process of the film H-13, the drying condition was controlled and therefore, even though the Nz factor could vary in the thickness direction of the film, the change is continuous in the thickness direction thereof, differing from the intermittent change in the films of the present invention, and therefore, the film H-13 could not sufficiently exhibit a circular retardation.

1. A retardation film comprising, as laminated in the thickness direction thereof, at least two layers of an optically anisotropic layer A containing at least one refractivity-anisotropic substance and a polymer A and an optically anisotropic layer B containing at least one refractivity-anisotropic substance in a ratio smaller than that in the optically anisotropic layer A, or not containing a refractivity-anisotropic substance, and containing a polymer B of which the main ingredient is the same as that of the polymer A, wherein the Nz factor of the optically anisotropic layers A and B intermittently differs in the thickness direction of the film.

2. The retardation film of claim 1, wherein the difference in the Nz factor of the optically anisotropic layers A and B is equal to or larger than 2.0.

3. The retardation film of claim 1, wherein the circular retardation at a wavelength of 550 nm in the direction at a polar angle of 60 degrees and an azimuth angle of 45 degrees is equal to or larger than 0.5 nm.

4. The retardation film of claim 1, which is formed by stretching a laminate of at least two layers of the optically anisotropic layer A and the optically anisotropic layer B formed through co-casting.

5. The retardation film of claim 1, which has Re-off of from 50 to 80 nm and Rth-off of from 190 to 230 nm.

6. The retardation film of claim 1, which has Re-off of from 45 to 65 nm and Rth-off of from 110 to 130 nm.

7. The retardation film of claim 1, of which the in-plane retardation Re and the thickness-direction retardation Rth show the same wavelength dispersion characteristics in a visible light region.

8. The retardation film of claim 1, of which the in-plane retardation Re and the thickness-direction retardation Rth show different wavelength dispersion characteristics in a visible light region.

9. The retardation film of claim 1, wherein the optically anisotropic layers A and B contain at least one cellulose acylate as a main ingredient.

10. The retardation film of claim 1, wherein the optically anisotropic layers A and B contain at least one cellulose acylate having at least two acylates selected from acetyl, propionyl and butyryl.

11. The retardation film of claim 1, wherein the at least one refractivity-anisotropic substance is a discotic compound having an absorption peak at a wavelength of from 250 nm to 380 nm.

12. The retardation film of claim 1, wherein the at least one refractivity-anisotropic substance is a liquid crystal compound.

13. The retardation film of claim 1, wherein the at least one refractivity-anisotropic substance is a compound represented by formula (A): 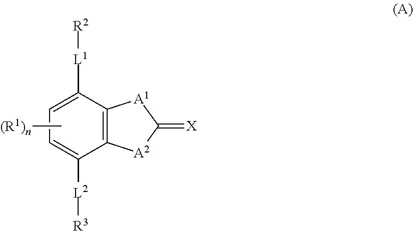
where L¹ and L² independently represent a single bond or a divalent linking group; A¹ and A² independently represent a group selected from the group consisting of —O—, —NR— where R represents a hydrogen atom or a substituent, —S— and —CO—; R¹, R² and R³ independently represent a substituent; X represents a nonmetal atom selected from the groups 14-16 atoms, provided that X may bind with at least one hydrogen atom or substituent; and n is an integer from 0 to 2.

14. The retardation film of claim 1, wherein the at least one refractivity-anisotropic substance is a compound represented by formula (a):
Ar¹-L²-X-L³-Ar² (a)
where Ar¹ and Are independently represent an aromatic group; L¹² and L¹³ independently represent —O—CO— or —CO—O—; X represents 1,4-cyclohexylen, vinylene or ethynylene.

15. The retardation film of claim 1, wherein the at least one refractivity-anisotropic substance is a compound represented by formula (I) 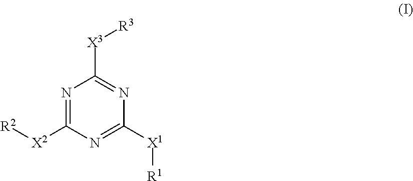
where X¹ represents a single bond, —NR⁴—, —O— or —S—; X² represents a single bond, —NR⁵—, —O— or —S—; X³ represents a single bond, —NR⁶—, —O— or —S—; R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

16. The retardation film of claim 1 having a thickness of from 30 to 200 micro meters.

17. A method of producing a retardation film of claim 1, which comprises:
preparing a liquid A that contains at least one polymer as the main ingredient and at least one refractivity-anisotropic material, and a liquid B1 that contains at least one polymer as the main ingredient but does not contain at least one refractivity-anisotropic material, or a liquid B2 that contains at least one polymer as the main ingredient and contains at least one refractivity-anisotropic material in a ratio smaller than that in the liquid A,
co-casting the liquid A and the liquid B1 or B2 onto the surface of a support to form a film thereon, and
stretching the film.

18. The method of claim 17, wherein the film is stretched at a draw ratio of from 1 to 300%.

19. The method of claim 17, wherein the liquid B1 or B2 is cast on the side nearer to the surface of the support.

20. The method of claim 17, which comprises preparing, along with the liquid A and the liquid B1 or B2, or in place of these, a liquid a having the same formulation as that of the liquid A but having a lower concentration than that of the liquid A, and/or a liquid b1 or b2 having the same formulation as that of the liquid B1 or B2 but having a lower concentration than that of the liquid B1 or B2, and co-casting them in the following order from the support surface side:
the liquid b1, the liquid B1 and the liquid a;
the liquid b1, the liquid A and the liquid a;
the liquid b2, the liquid A and the liquid a;
the liquid b1, the liquid B1, the liquid A and the liquid a; or
the liquid b2, the liquid B2, the liquid A and the liquid a.

21. The method of claim 17, wherein the formulation of the liquid A and the liquid B1 or B2 satisfies the following condition:
(Condition)
when the liquid A and the liquid B1 or B2 are each independently cast under the same condition and then stretched under the same condition, the Nz factor of the resulting two films differs by at least 2.0.

22. A polarizing plate comprising a polarizing film and a retardation film of claim 1 on at least one surface of the polarizing film.

23. The polarizing plate of claim 22, wherein the surface having a higher Nz factor of the retardation film is stuck to at least one surface of the polarizing film.

24. A liquid crystal display device comprising:
a liquid crystal cell,
at least one polarizing film, and
a retardation film of claim 1 disposed between the liquid crystal cell and the polarizing film.

25. The liquid crystal display device of claim 24, employing a vertically-aligned mode.
